(19) United States
(12) Patent Application Publication
(10) Pub. No.: US 2004/0191692 A1
(43) Pub. Date: Sep. 30, 2004

(54) Support for lithographic printing plate and presensitized plate and method of treating presensitized plate

(75) Inventors: Hirokazu Sawada, Shizuoka (JP); Akio Uesugi, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/765,471

(22) Filed: Jan. 28, 2004

(30) Foreign Application Priority Data
Jan. 29, 2003 (JP) 2003-019868

(51) Int. Cl. G03C 1/76

(52) U.S. Cl. 430/302; 430/278.1

(57) ABSTRACT

A support for a lithographic printing plate is obtained by performing graining treatment including electrochemical graining treatment on an aluminum plate, wherein the aforementioned aluminum plate contains Fe of 0.05 to 0.29 wt %, Si of 0.03 to 0.15 wt %, Cu of 0.020 to 0.050 wt % and Ti of 0.05 wt % or less and the remaining portion of the aluminum plate is composed of aluminum and unavoidable impurities. The support and a presensitized plate obtained by an image recording layer on the support are excellent in all of sensitivity, cleaner press life, scum resistance and press life when the printing plate is prepared from the support and the presensitized plate.

### BACKGROUND OF THE INVENTION

1. Filed of the Invention

The present invention relates to a support for a lithographic printing plate, a presensitized plate, and a method of treating a presensitized plate. More particularly, the present invention relates to a presensitized plate excellent in all of sensitivity, cleaner press life, scum resistance and press life when a lithographic printing plate is prepared, a support for a lithographic printing plate used for the same and a method of treating a presensitized plate. Specifically, the present invention relates to the presensitized plate where development can be performed with a developer substantially containing no alkali metal silicates after exposure, the support for a lithographic printing plate used for the same and the method for treating the presensitized plate, and the presensitized plate where dotted exposure defective areas called dot residual layers are unlikely to occur in plate making using a laser source and the support for a lithographic printing plate used for the same, in addition to the aforementioned characteristics by attaching Si atoms to the surface of the support for a lithographic printing plate.

2. Description of the Related Art

A photosensitive presensitized plate provided with an aluminum plate as a support is widely used for offset lithography.

Known as a method of preparing the presensitized plate is generally the method that after graining treatment and anodizing treatment are performed on the surface of a sheeted or coiled aluminum to obtain a support for a lithographic printing plate, a photosensitive solution is coated on the support and is dried to form an image recording layer, and the support provided an image recording layers is cut into a desired size if required. After an image is printed, development processing is performed on the presensitized plate to prepare a lithographic printing plate.

In the method, it is effective to perform electrochemical graining treatment in an acid solution (also referred to as “electrolytic graining treatment” according to the present invention) in order to improve adhesion between the image recording layer and the support, and it is also effective to perform a surface treatment and coat an undercoat solution after anodizing treatment is performed.

If graining treatment including electrolytic graining treatment is performed, fine irregularities (pits) are produced on the surface of the support. It is conventionally considered that by equalizing and increasing the diameters and deepening the depth, the adhesion between the image recording layer and the support is strengthened in the image areas, the image recording layers are not exfoliated or the like even though a number of sheets are printed, and a large amount of fountain solution can be held in non-image areas, scum is hardly produced, and thus, a presensitized plate excellent in printing property can be obtained. For example, the method of improving the shape and uniformity of electrolytically grained pits from such a viewpoint is proposed in JP 2000-108534 A, JP 2000-37965 A and JP 2000-37964 A.

### SUMMARY OF THE INVENTION

However, the inventors have thoroughly studied and found that the pits on the surface of the support is almost bowl shaped, the diameters are uniform and big, in addition, if the depth is deep, the adhesion between the image recording layer and the support is sufficiently strengthened by allowing the image recording layer to fill the bottom portions of the pits. On the other hand, since the image recording layer is relatively thin and the edge portions of the pits are sharp in the edge portions of the pits, a strong stress is likely to be applied to the image recording layer provided on the edges of the pits in printing, and thus, the portion of the image recording layer is likely to be broken or exfoliated.

Although the method by which the sharpness of the edge portions are chemically dissolved is known, the inventors have found that if the edge potions are dissolved, the number of press life sheets (the number of printed sheets until printing is disabled by the exfoliation or wear of the image recording layer in the image areas of the lithographic printing plate) is likely to deteriorate. Namely, it is difficult to strengthen both the adhesion between the image recording layer in deeply recessed areas and the support, and the adhesion between the image recording layer at the edge portions of the pits and the support, and it is also difficult to simultaneously satisfy both press life and scum resistance. In addition, the inventors have also found that the phenomenon that the image recording layer is exfoliated (difficulty of achieving press life and scum resistance simultaneously) is not only observed in a conventional-type presensitized plate but also significantly observed in a laser directly-exposed image-type presensitized plate (a presensitized plate for laser printing).

By the way, in offset lithography, ink is not directly transferred from the printing plate to the impression material such as a printing paper, but the ink is once transferred from a lithographic printing plate wound round a plate cylinder to an elastic rubber cloth (blanket) wound round a transfer cylinder, printing is performed by contacting and pressurizing the blanket to which the ink is transferred and the impression material supplied by the impression cylinder.

If the pits in the non-image areas are uneven, since the retention of the fountain solution in the non-image areas is insufficient and the ink is allowed to enter there, the ink is attached to the non-image areas of the printing plate, thereby causing scum to be produced. The scum is transferred to the blanket and finally appears as the scum of a printed matter. In order to prevent the scum of the printed matter like this, normally, the scum of the printing plate is prevented by suspending the operation of a printing press to wash away the ink attached to the non-image areas and by increasing the supplied amount of the fountain solution at a time when the scum of the blanket is observed and confirmed. Cleaning is performed by wiping the entire printing plate, namely, the image areas and the non-image areas with a sponge moistened with the proper amount of an acid or alkali plate cleaner solution. By doing so, the ink attached to the non-image areas on the printing plate is removed.

If the entire printing plate is cleaned with the plate cleaner solution, since the image recording layer is swollen by the cleaner solution, thereby deteriorating the strength of the image recording layer or the cleaner solution penetrates between the image recording layer and the support, thereby deteriorating the adhesion therebetween. If a large number of printing is performed after the printing plate is cleaned, the image recording layer is likely to be worn or exfoliated in the solid image areas whose friction area with the blanket is big or in the highlighted image areas whose contact area with the support is small. Therefore, it is preferable that the lithographic printing plate is excellent in press life even after cleaned with the plate cleaner solution.

In addition, it is generally performed that Si atoms are attached to only the non-image areas from which the image recording layer is removed to further improve the water wettability of the non-image areas by containing an alkali metal silicate in a developer to improve the scum resistance of the lithographic printing plate. However, if development is performed by using a developer containing an alkali metal silicate, there are problems that solid matters attributable to SiO₂ are likely to precipitate, gels attributable to SiO₂ in a neutral treatment when a waste developer is treated are likely to produce or the like.

On the other hand, proposed is the technology that development is performed with a developer substantially containing no alkali metal silicate by providing a recording layer after the surface of a support for a lithographic printing plate which is to be the non-image area of the lithographic printing plate is previously treated which the solution containing an alkali metal silicate (for example, JP 11-109637 A or the like). However, in these technologies, there was a defect that the adhesion between the image recording layer and the support becomes weaker.

The inventors have proposed that of the irregularities on the surface of the support for a lithographic printing plate, a grained structure with large undulation and the diameter of a pit are limited to the-specified ranges, further, the pore diameter of a micro pore existent in an anodized layer and the pore density of the layer are limited to the specified ranges, and the-content of copper in aluminum is preferably limited to a certain range or less (JP 2001-74171). In addition, JP 1-47545 B and JP 8-337835 A describe that the content of copper is limited to a certain range.

However, it could not be still said that the adhesion between the image recording layer and the support was sufficient in these methods and scum resistance in the non-image area was sufficient. And, in these methods, there were cases where the mechanical strength of the support was insufficient.

Furthermore, if in these methods, a laser-exposed type image recording layer was used, there was a defect that an area where the image recording layer has entered a locally deep recess produced by removing an intermetallic compound existent in an aluminum plate in graining treatment or by dropping of the same became a starting point, and a locally defective exposure or a defective development after exposure was likely to take place since the image recording layer was thickly formed. Consequently, dot-shaped residual layers (called dot residual layers) occurred.

Therefore, the present invention is intended to provide a presensitized plate 1) which has neither locally defective exposure nor defective development and is excellent in sensitivity even if a laser exposed-type image recording layer is used, 2) where the adhesion between the image recording layer and the support is strong, and there is no problem that the image recording layer on the edge of the pits is likely to be broken or exfoliated and press life is excellent when the lithographic printing plate is prepared, 3) which is also excellent in stain-resistance (referred to as “scum resistance” in the present invention), and 4) which is also excellent in press life after the plate surface is cleaned with the plate cleaner solution (also referred to as “cleaner press life”) and the support for a lithographic printing plate used for the same. Namely, the present invention is intended to provide the presensitized plate excellent in all of the sensitivity, cleaner press life, scum resistance and press life when the lithographic printing plate is prepared and the support for a lithographic printing plate used for the same.

In addition, the present invention is intended to provide the presensitized plate excellent in all of the sensitivity, cleaner press life, scum resistance and press life when the lithographic printing plate is prepared and further excellent in mechanical strength and the support for a lithographic printing plate used for the same.

Furthermore, the present invention is intended to provide the support for a lithographic printing plate excellent in surface quality (external appearance) besides the aforementioned characteristics and the presensitized plate which uses the same.

Moreover, the present invention is intended to provide the presensitized plate which is excellent in all of the sensitivity, cleaner press life, scum resistance and press life when the lithographic printing plate is prepared even if a laser exposed-type image recording layer is used and can be treated with a developer containing no alkali metal silicate and the support for a lithographic printing plate used for the same and a method of treating the presensitized plate.

The inventors have thoroughly studied and found that sensitivity, cleaner press life, scum resistance and press life can be realized in a well balanced manner at a high level when the lithographic printing plate is prepared by specifying a metal element contained in an aluminum plate and its content.

In addition, the inventors have also found that the aforementioned characteristics are realized in a well balanced manner at a higher level, thereby mechanical strength (handling property) and surface quality (external appearance) are excellent by specifying the relation between the thickness of the aluminum plate and tensile strength TS in a rolling direction, the physical properties of an intermetallic compound, or the size of crystal grains in the aluminum plate, besides the specification of the aforementioned metal element or the like.

Furthermore, the inventors have found that the presensitized plate where a laser exposed-type image recording layer is provided on the support for a lithographic printing plate obtained by specifying these categories maintains the aforementioned characteristics and development treatment can be performed on the plate with a developer containing no alkali metal silicate.

Namely, the present invention is materialized based on the aforementioned findings and provides the following (I) to (VIII).

(I) A support for a lithographic printing plate obtained by performing graining treatment including electrochemical graining treatment on an aluminum plate, wherein the aforementioned aluminum plate contains Fe of 0.05 to 0.29 wt %, Si of 0.03 to 0.15 wt %, Cu of 0.020 to 0.050 wt % and Ti of 0.05 wt % or less and the remaining portion is composed of aluminum and unavoidable impurities.

(II) The support for a lithographic printing plate according to the aforementioned (I), wherein the aluminum plate is such that the plate thickness t (mm) thereof is 0.10 to 0.50 (mm) and the relation between the aforementioned plate thickness t (mm) and the tensile strength TS (MPa) of the aforementioned aluminum plate in a rolling direction satisfies the following equation [I].

−98.6×t+170≦TS (MPa)≦−98.6×t+200 Equation [I]

(III) The support for a lithographic printing plate according to the aforementioned (I) or (II), wherein the aforementioned aluminum plate is such that for an intermetallic compounds are existent on the surface thereof, an intermetallic compound with a circle equivalent diameter of 1 μm or more is of 6,000 pcs/mm² or less and the rate of the intermetallic compound with a circle equivalent diameter of 1 to 10 μm is 85% or higher. (IV) The support for a lithographic printing plate according to any one of the aforementioned (I) to (III), wherein the aforementioned aluminum plate is such that for crystal grains located in the areas up to 50 μm deep from the surface thereof, the width in a direction perpendicular to a plate rolling direction is an average of 80 μm or less and a maximum of 150 μm or less, and of the length of the plate rolling direction is an average of 400 μm or less and a maximum of 500 μm or less.

(V) The support for a lithographic printing plate according to any one of the aforementioned (I) to (IV), wherein Si atom adhesion quantity onto the surface of the aforementioned aluminum plate is 0.1 to 30 mg/m².

(VI) A presensitized plate provided with an image recording layer on the support for a lithographic printing plate according to any one of the aforementioned (I) to (V).

(VII) The presensitized plate according to the aforementioned (VI), which is a presensitized plate for a laser printing plate.

(VIII) A method of treating a presensitized plate, wherein after exposure is performed on the presensitized plate according to the aforementioned (VI) or (VII), development is performed with a developer substantially containing no alkali metal silicates and containing saccharides.

### BRIEF DESCRIPTION OF DRAWINGS

FIG. 1 is a side view showing a process concept of a brush graining treatment used for mechanical graining treatment in the preparation of a support for a lithographic printing plate according to the present invention;

FIG. 2 is a graph showing an example of alternating current wave diagrams used for electrolytic graining treatment in the preparation of the support for a lithographic printing plate according to the present invention;

FIG. 3 is a side view showing an example of a radial-type cell in electrochemical graining treatment with alternating current in the preparation of the support for a lithographic printing plate according to the present invention; and

FIG. 4 is a schematic view of anodizing device used for anodizing treatment in the preparation of the support for a lithographic printing plate according to the present invention.

### DETAILED DESCRIPTION OF THE PREFERRED EMBODIMENTS

Hereafter, the present invention will be described in detail.

[Support for Lithographic Printing Plate]

<Aluminum Plate (Rolled Aluminum)>

The support for a lithographic printing plate according to the present invention uses an aluminum alloy. The essential alloy components in the aluminum alloy are Al, Fe, Si and Cu, and Ti is preferably contained.

Fe of about 0.04 to 0.2 wt % is usually contained in an aluminum alloy (Al base metal) used as a raw material. A quantity of Fe which is solid-solved in aluminum is small and most of the quantity remains as an intermetallic compound. Fe has a function to increase the mechanical strength of an aluminum alloy and greatly affects the strength of a support for lithographic printing plate. If the content of Fe is too low, since the mechanical strength is too small, plate-tear is likely to take place when a lithographic printing plate is mounted on the plate cylinder of a printing press. In addition, when a massive printing is performed at a high speed, plate-tear is likely to occur similarly. On the other hand, if the content of Fe is too high, the printing plate is highly hardened, the printing plate is poor in fitness when a lithographic printing plate is mounted on the plate cylinder of a printing press, and plate-tear is likely to occur during printing. In addition, if the content of Fe is, for example, higher than 1.0 wt % or more, cracking is likely to take place during the rolling of the lithographic printing plate.

The inventors have found that the intermetallic compounds containing Fe later described largely occupy the intermetallic compounds contained in the aluminum plate, and that they are easily removed (easily dropped) in graining treatment, and this removal of the compounds causes defective exposure and defective development by allowing the image recording layer to enter local recesses formed after they are removed (dropped) (later described in detail).

In the present invention, the printing plate is excellent in mechanical strength by setting the upper limit of Fe content at 0.29 wt % based on the aforementioned findings or the like. In addition, the quantity of the intermetallic compounds containing Fe becomes smaller by setting the upper limit of Fe content at 0.29 wt %, since the local recesses formed after the intermetallic compounds are removed (dropped) are reduced, neither defective exposure nor defective development being likely to occur and sensitivity is excellent.

Although it is appropriate to set a lower limit of Fe content at 0.05 wt % or more considering the content of Fe in the base metal, it is more preferable that the lower limit is set at 0.20 wt % or more to keep the mechanical strength.

Representative examples as the intermetallic compounds containing Fe are Al₃Fe, Al₆Fe, AlFeSi-type compounds, AlFeSiMn-type compounds or the like.

Si is an element of about a 0.03 to 0.1 wt % unavoidable impurity contained in an aluminum base metal which is a raw material, and there are many cases where a trace of the element is intentionally added to prevent the dispersion by the difference in raw materials. In addition, Si is an element which is much contained in a scrap aluminum. Si is existent in a state where it is solid-solved in Al or in the form of an intermetallic compound or a simple deposit. In addition, if the element is heated in the preparing process of the support for a lithographic printing plate, the solid-solved Si may be deposited as a chemical element of Si. According to the findings of the inventors, if a chemical element of Si is excessive, severe ink scum resistance may deteriorate. Here, “severe ink scum” means a scum that if printing is performed while it is suspended many times, ink is likely to be easily attached to the surface area of a lithographic printing plate, which results in appearing a dot or circular scum on a printed paper or the like. In addition, Si affects electrolytic graining treatment.

Furthermore, if the content of Si is high, an anodizing layer becomes defective when anodizing treatment is performed after graining treatment, the water retaining property of the defective areas is poor, thereby paper is likely to be fouled at the time of printing.

In the present invention, the content of Si is 0.03 wt % or more and is 0.15 wt % or lower. It is preferably 0.04 wt % or more and is 0.1 wt % or lower in that the stability of electrolytic graining treatment is excellent.

Cu is a very important element in controlling electrolytic graining treatment and is an essential component in the present invention. Since the diameters of pits produced by electrolytic graining treatment in a nitric acid solution can be made higher by setting the content of Cu at 0.020 wt % or more, water retention of fountain solution in the non-image areas can be largely secured when printing is performed after exposure and development, thereby scum resistance is improved. On the other hand, if the content of Cu is more than 0.050 wt %, since the diameters of pits produced by electrolytic gaining treatment in a nitric acid solution are too big and the uniformity of the diameters deteriorates, scum resistance is particularly poor.

In addition, the inventors have found that the pits with diameters of 0.5 μm or less produced by electrolytic graining treatment in a hydrochloric acid solution can be equalized and the increment rate of the surface area on the surface of the support can be maximized by setting the content of Cu in this range. Since the contact area with the image recording layer can be made bigger by increasing the increment rate of the surface area, the adhesion on the areas is improved, thereby the printing plate is excellent in press life and cleaner press life. In addition, scum resistance is excellent when a lithographic printing plate is prepared.

In the present invention, from the aforementioned viewpoint, the content of Cu is 0.020 to 0.050 wt %, and preferable is 0.020 to 0.030 wt %.

Conventionally, Ti of 0.05 wt % or less is usually contained as a crystal fining material to make a crystal structure fine. If the content of Ti is too high, since the resistance of the surface anodized layers in electrolytic graining treatment, particularly, in electrolytic graining treatment in a nitric acid aqueous solution becomes too small, uniform pits may not be formed. In the present invention, the content of Ti is 0.05 wt % or less and preferable is 0.03 wt % or less.

In addition, Ti may not be contained in an aluminum plate, and although the content may be low, it is preferable that the content of Ti is 0.005 wt % or more to increase a crystal fining effect, and more preferable is 0.01 wt % or more.

Although Ti is mainly added as an intermetallic compound with Al or TiB₂, it is preferable that Ti is added as an Al—Ti alloy or an Al—B—Ti alloy to increase the crystal fining effect. Note that if Ti is added as the Al—B—Ti alloy, a trace of B is contained in an aluminum alloy. However, the effect of the present invention is not damaged.

If an aluminum plate containing the aforementioned different elements in the aforementioned range is used, since uniform and big pits are formed in a range which does not deteriorate sensitivity in the electrolytic graining treatment later described, the plate is excellent in all of sensitivity, cleaner press life, press life and scum resistance when the lithographic printing plate is prepared.

The remaining portion of the aluminum plate is composed of aluminum and unavoidable impurities. Most of the unavoidable impurities is contained in an aluminum base metal. If the unavoidable impurities are contained, for example, in the base metal of aluminum purity of 99.7%, the effect of the present invention is not damaged. For unavoidable impurities, impurities of amounts described, for example, in “Aluminum Alloys: Structure and Properties” authored by L. F. Mondolfo (1976) or the like may be contained.

Unavoidable impurities contained in an aluminum alloy includes, for example, Mg, Mn, Zn, Cr or the like, and these elements of 0.05 wt % or less may be each contained. For other elements than these elements, the contents conventionally known to the public may be contained.

According to one of the preferable embodiments, the aluminum plate used in the present invention is an aluminum plate which has the aforementioned composition, and has a plate thickness t (mm) of 0.10 to 0.50 (mm), and in which the relation of the plate thickness t (mm) and the tensile strength TS (MPa) in a rolling direction satisfies the following equation (I):

−98.6×t+170≦TS (MPa)≦−98.6×t+200

The inventors have thoroughly studied the plate-tear due to a weak mechanical strength and the plate-tear in printing due to a low fitness caused by a strong mechanical strength when the lithographic printing plate is mounted on the plate cylinder of a printing press and found that the thickness t and tensile strength TS of the aluminum plate should satisfy the aforementioned specific relation to simultaneously overcome these phenomena and prepare a support for a lithographic printing plate excellent in handling property.

Namely, the inventors have thoroughly studied the improbability of the plate-tear when the lithographic printing plate is mounted on the plate cylinder of the printing press and the plate-tear in printing and found that the area in which the plate-tear hardly takes place is of the aluminum plate with thickness t of 0.10 to 0.50 mm and is an area that the thickness t (mm) of the aluminum plate and the tensile strength TS (MPa) of the aluminum plate in a rolling direction satisfies a relation expressed by the aforementioned equation [I].

If tensile strength TS (MPa) is the left-hand side “−98.6×t+170” or more in the aforementioned equation [I], since the printing plate has a sufficient breaking strength when the printing plate is mounted on the plate cylinder of the printing press while a tension is being given to the printing plate by a clamp mechanism called “a mouth” on the plate cylinder of the printing press, plate-tear does not take place when the printing plate is mounted on the plate cylinder of the printing press. On the other hand, If tensile strength TS (MPa) is right-hand side “−98.6×t+200” in the aforementioned equation [I] or less, since fatigue rupture hardly occurs, plate-tear in printing does not take place in printing.

Methods of preparing an aluminum plate that the thickness t of the aluminum plate and the tensile strength TS of the aluminum plate in a rolling direction satisfy the relation in the aforementioned [I] include, for example, the method of adjusting the thickness of an aluminum plate where rolling is performed in an annealing process of the aluminum plate, the method of adjusting the draft in a final rolling process, the method where a process called an intermediate annealing is performed at an early stage at a time when the thickness of the aluminum plate is big or the like. In addition, it is known that Fe, Cu, Mg or the like contained in aluminum affects the strength of an aluminum alloy, and thus the method of adjusting the contents of these elements is also added.

Tensile strength TS of the aluminum plate in a rolling direction can be measured based on JIS Z2201 and JIS Z2241 with, for example, Shimazu Corporation-made Auto Graph or the like.

In addition, one of the preferable embodiments is that the aluminum plate used in the present invention is an aluminum plate further, for the intermetallic compound consisting of two kinds or more of elements containing the aforementioned metal elements existent on the surface of the aluminum plate, an intermetallic compound with a circle equivalent diameter of 1 μm or more is 6,000 pcs/mm² or less and the rate of an intermetallic compound with a circle equivalent diameter of 1 to 10 μm is 85% or higher.

Fe contained in an aluminum plate is likely to form intermetallic compounds with aluminum as described above, and these intermetallic compounds are important as a starting point of pit formation in electrolytic graining treatment. However, the intermetallic compounds are likely to be removed or dropped from the surface of the aluminum plate when electrolytic graining treatment or the like is performed, and big and deep recesses are formed on the surface of the aluminum plate after the intermetallic compounds are removed or dropped. If a presensitized plate is prepared by providing an image recording layer on the surface of a support having the recesses like this, the provided image recording layer fills the recesses and the image recording layer is thickened in the areas. If so, exposure energy can not sufficiently reach the bottom of the recesses at the time of exposure (defective exposure occurs), the image recording layer can not be efficiently removed by development treatment (defective development occurs), since the image recording layer is left in the recesses, dot residual layers or the like may be produced, thereby deteriorating sensitivity.

The inventors have found that the formation of the deep recesses generated by the dropping of the intermetallic compounds in a surface treatment treatment or the like can be suppressed to prevent defective exposure and defective development by controlling the pieces and the occupation rate of the intermetallic compounds on the surface of the aluminum plate in the aforementioned specific range and that a presensitized plate suitable for particularly, plate making which uses a laser light source can be obtained.

Furthermore, according to the findings by the inventors, if the number of intermetallic compound with a circle equivalent diameter of 1 μm or more existent on the surface of the aluminum plate is more excessive than 6,000 pcs/mm², the defect of anodizing layers is increased.

Intermetallic compounds consisting of two kinds or more of the aforementioned metal elements include, for example, intermetallic compounds consisting of two kinds of elements such as Al₃Fe, Al₆Fe, Mg₂Si, MnAl₆, TiAl₃ and CuAl₂; intermetallic compounds consisting of three kinds of elements such as α-AlFeSi and β-AlFeSi and intermetallic compounds consisting of four kinds of elements such as α-AlFeMnSi and β-AlFeMnSi.

When elements contained in an aluminum plate or added to a molten aluminum are solidified in a casting process, a part thereof is dissolved in the aluminum plate (solid-solved), solved), and the remaining portion is existent as intermetallic compounds, separate crystals or deposits. The rate of the aforementioned elements left as intermetallic compounds, separate crystals or deposits are largely affected by solidification rate. For example, if the aforementioned elements are rapidly solidified as in a process adopting roller-type continuous casting, most of them are solid-solved. If a casting process with a slow solidification rate as in DC casting process is adopted, the aforementioned elements are likely to be left in the form of intermetallic compounds, separate crystals or deposits.

Thereafter, although most of the aforementioned elements are solid-solved again in the aluminum plate or are converted into more stable intermetallic compounds or the like in the heat treatment processes such as soaking and annealing or hot rolling process, there are many cases where the aforementioned elements are existent in the form of intermetallic compounds, separate crystals or deposits on the surface of the aluminum plate or in the aluminum plate at a time when the aluminum plate is of thickness of about 0.1 to 07 mm for a lithographic printing plate.

Since the intermetallic compound plays a role like a spike and also has an anchor effect between a support for a lithographic printing plate and an image recording layer, the adhesion between the two substances is improved, and an excellent press life can be obtained when a lithographic printing plate is prepared. It is preferable that a plurality of kinds of intermetallic compounds and different forms of intermetallic compounds are particularly mixed to improve adhesion and press life.

It is preferable that of the intermetallic compounds existent on the surface of the aluminum plate in the present invention, the number of the intermetallic compound with a circle equivalent diameter of 1 μm or more is 6,000 pcs/mm² or less, and more preferable is 5,500 pcs/mm² or less. If the number of intermetallic compound per unit area stays in the aforementioned range, the lithographic printing plate is excellent in press life and sensitivity.

It is preferable that the rate (occupation rate) of intermetallic compound with a circle equivalent diameter of 1 to 10 μm to the total quantity of the intermetallic compounds existent on the surface of the aluminum plate is 85% or higher.

An intermetallic compound is important as a starting point of a pit formation in electrolytic graining treatment. However, if a circle equivalent diameters of intermetallic compounds vary and if there are a number of the intermetallic compounds with a circle equivalent diameter of more than 10 μm, pits generated by electrolytic graining treatment are uneven and the lithographic printing plate may be poor in press life. In addition, the lithographic printing plate may be poor in sensitivity since defective exposure and defective development are generated by allowing deep and big recesses to be formed as described above. Furthermore, since the quantity of defective anodizing layers is affected, the lithographic printing plate may be poor in sever ink scum resistance.

It is more preferable that the rate of intermetallic compound with a circle equivalent diameter of 1 to 10 μm is 90% or higher since the lithographic printing plate is excellent in sensitivity, press life and sever ink scum resistance.

The kind, a circle equivalent diameter and occupation rate of an intermetallic compound can be controlled by each changing the added quantities of raw materials, for example, low-purity scrap materials such as UBC materials and secondary base material.

The kind and occupation rate of an intermetallic compound can be easily calculated by observing an aluminum plate with SEM (scanning electron microscope) or the like and, for example, counting the number of the intermetallic compounds in a range of 60 μm×50 μm at 5 positions (n=5) to convert the number into the value per 1 mm². The measurement of a diameter of the intermetallic compound can be performed by using the same method.

In addition, the calculation can be performed by, for example, the following methods with EPMA (electronic probe micro analyzer).

It is preferable that an oil content on the surface of the aluminum plate is wiped out with acetone to prepare a measurement specimen in the measurements of a circle equivalent diameter and an occupation rate of an intermetallic compound.

A composition image prepared by using a reflector absorption spectroscopic electronic detector under the conditions of accelerating voltage of 20.0 kV, irradiation current of 9.5×10⁻⁹ A is electronically photographed at a magnification of 500 with EPMA to obtain an instant photography.

Next, the reflector electronic photography (instant photography) is converted into a bmf (bit map file) format, and the file is read into an image analytical software to perform an image analysis. Static binary processing is performed on the image, the number of the void areas corresponding to the intermetallic compound is counted, a circle equivalent diameter (equivalent round diameter) is designated as a special trace to obtain circle equivalent diameter distribution.

Furthermore, one of the preferable embodiments is that the aluminum plate used in the present invention is an aluminum plate where with regard to the crystal grain located in the areas up to 50 μm deep from the surface of the aluminum plate, width in a vertical direction in a plate rolling direction (hereinafter merely referred to as “width”) is an average of 80 μm or less (preferably 50 μm or less) and a maximum of 150 μm or less (preferably 120 μm or less), length in the plate rolling direction (hereinafter merely referred to as “length”) is an average of 400 μm or less (preferably 350 μm or less) and a maximum of 500 μm or less (preferably 450 μm or less).

The characteristics of the crystal grains (sizes) like this can be controlled by the method where annealing is performed by a continuous annealing furnace after hot rolling or the method where cold rolling is performed one or more time after hot rolling.

If the size of crystal grains existent in the predetermined depth-area of the aluminum plate is set at the predetermined value or less, more crystal grains per unit area are inevitably existent. Since the metallic composition of the aluminum plate is composed of crystal grains and crystal grain interfaces which are their boundaries, the existence of more crystal grains means more crystal grains and crystal grain interfaces. And, if more crystal grains and crystal grain interfaces are existent, the propagation of fine cracks generated by repeated bending hardly advances, the fatigue rupture of a lithographic printing plate which has been conventionally problematic hardly takes place. In addition, the surface quality of the printing plate (external appearance) is better improved, and the lithographic printing plate is excellent in plate inspection property when the lithographic printing plate is prepared. Particularly, since fine cracks are likely to occur in the vicinity of the surface layer of the plate, the crystal grains located up to the area of 50 μm deep from the surface are important.

As a method of checking crystal grains, a method with a general macro etching can be used.

As an etching solution for observing the crystal grains, hydrofluoric acid aqueous solution, a plural-acid aqueous solution or the like can be used.

The crystal grains are observed by a method that a polished and etched sample is photographed with an optical microscope using a polarizing filter. The width and length of the crystal grain are measured and the average value and the maximum value can be obtained.

In addition, if the foregoing is confirmed with the support for a lithographic printing plate according to the present invention or the presensitized plate according to the present invention, since graining treatment or photosensitive layer coating is performed on at least one side of the plate and, for example, a protective layer for suppressing the elution of aluminum at the time of development is also coated on the other side of the plate on which a photosensitive layer is not applied or the like, the crystal grains may be hardly checked with a simple macro etching. For that reason, it is appropriate that after a semi-mirror finish is performed on the surface of the plate by mechanical polishing or electrochemical polishing, etching is performed with a predetermined etching solution for easier observation of the crystal grains, and then observation is performed.

Here, The methods of mechanical polishing include, for example, the method using a polishing paper and the method using an abrasive and a puff. The method of electrochemical polishing includes, for example, the method where direct current electrolytic polishing is performed in sulfuric acid, phosphoric acid or the like.

It is preferable that after annealing is performed, cold rolling is performed to extend the crystal grain to that of a proper length. With this method, the tensile strength of the plate is improved, and cracking can be hardly propagated in a plate width direction since the crystal grain interface is extended in a rolling direction. However, it is not preferable that the number of crystal grains per unit area is reduced if the plate is extended more than requires.

The planarity of the aluminum plate finished with a predetermined thickness of 0.10 to 0.50 mm in cold rolling may be further improved by sizing devices such as a roller leveler and a tension leveler. In addition, passage of slitter line is usually performed to machine the plate into a predetermined plate width.

Next, the method of manufacturing the aluminum plate according to the present invention will be described.

When an aluminum alloy is manufactured as a plate material, the following methods, for example, can be used.

First, purification treatment is performed on a molten aluminum alloy prepared so as to have a predetermined alloy component content according to the conventional method to perform casting. In the purification treatment, unnecessary gases such as hydrogen gas and solid impurities mixed in the molten metal are removed. The purification treatments to remove unnecessary gases include, for example, flux treatment; degassing treatment which uses argon gas, chlorine gas or the like. In addition, the purification treatments to remove solid impurities include, for example, filtering treatment which uses rigid media filters such as ceramic tube filter and ceramic foam filter, filters with filter media such as alumina flake and alumina ball and glass cross filter. Moreover, the purification treatment in combination of degassing treatment and filtering treatment can be performed.

It is preferable that these treatments are performed to prevent defects attributable to foreign matters such as non-metal inclusion and oxides in the molten metal or defects caused by gasses dissolved in the molten metal. As molten metal filtering treatments, for example, the methods described in JP 6-57342 A, JP 3-162530 A, JP 5-140659 A, JP 4-231425 A, JP 4-276031 A, JP 5-311261 A and JP 6-136466 A can be used. In addition, as molten metal degassing treatment, for example, the methods described in JP 5-51659 A, JP 5-51660 A, JP 5-49148 A and JP 7-40017 A can be used.

Subsequently, casting is performed on the aluminum alloy molten metal in either a casting process using a stationary mold represented by DC casting process or a casting process using driven mold represented by a continuous casting process.

In DC casting the molten metal is solidified at the cooling rate ranging from 1 to 300° C./sec. If the cooling rate is less than 1° C./sec, a number of coarse intermetallic compounds may be formed. If DC casting is performed, an ingot with plate thickness of 300 to 800 mm can be manufactured.

As a continuous casting process, the Hunter method and the method using a cooling roller represented by 3C method, the Huzley method and the method using a cooling belt or a cooling block represented by Alusuisse-made caster II type are utilized in the casting industry. If the continuous casting method is used, the molten metal is solidified at the cooling rate ranging from 100 to 1,000° C./sec. Since the cooling rate of the continuous casting method is generally faster than that of DC casting method, the former has a characteristic that the degree of solid solution of alloy component to an aluminum matrix can be increased. For the continuous casting method, for example, the methods described in JP 3-79798 A, JP 5-201166 A, JP 5-156414 A, JP 6-262203 A, JP 6-122949 A, JP 6-210406 A and JP 6-262308 A can be used.

Since, in case of DC casting method, an ingot with plate thickness of 300 to 800 mm is manufactured, the surface of the ingot is cut by 1 to 30 mm, preferably 1 to 10 mm by facing according to a conventional method. Thereafter, soaking treatment is performed if required. If soaking treatment is performed, thermal treatment is performed at 450 to 620° C. for 1 to 48 hours so as not to allow an intermetallic compound to-be large-sized. If the time is less than 1 hour, the effect of soaking treatment may be insufficient. If the stabilization of the intermetallic compound is not required, soaking treatment can be omitted.

Thereafter, hot rolling and cold rolling are performed to manufacture the rolled plate of the aluminum alloy plate. It is appropriate that the starting temperature of the hot rolling is 350 to 500° C. Intermediate annealing treatment may be performed before or after the hot rolling or halfway the hot rolling. The conditions are that the plate is heated at 280 to 600° C. for 2 to 20 hours using a batch-type annealing furnace, preferably is heated at 350 to 600° C. for 2 to 10 hours or the plate is heated at 400 to 600° C for 6 minutes or less using a continuous annealing furnace, preferably is heated at 450 to 550° C. for 2 minutes or less. A crystal structure can be made fine by heating the plate at a rate of temperature rise of 10° C./sec using a continuous annealing furnace. The cold rolling is described, for example, in JP 6-210308 A.

For the aluminum alloy plate finished with a predetermined thickness of 0.10 to 0.50 mm by the aforementioned processes, the planarity of the same may be improved by sizing devices such as a roller leveler and a tension leveler.

It is preferable that the aluminum plate is of the sectional shape as follows:

The aluminum plate is normally stored for a predetermined period of time with the same wound as coil. In a plate cross section, if an end of the plate, that is, an ear section is too thick, the thick areas are plastic deformed while the plate wound as coiled in several thousand meters is stored, and a distortion at the end called an ear distortion is generated. Similarly, if the internal side of the plate is too thick, plastic deformation is generated to cause a deformation inside the plate called a gut distortion.

Since the gut distortion is unlikely to occur as compared to the ear distortion, it is preferable that in the present invention, top priority is given to the prevention of occurrence of ear distortion, and that the plate thickness of the internal side of the plate is somewhat bigger than that of the end of the plate in finished conditions. Concretely, it is preferable that a-value as defined below is determined to be 1.0 or less in order to allow the plate thickness of the ear section with respect to the average plate thickness of the plate to be a certain thickness or less. In addition, it is preferable that pc value as defined below is determined to be 2.0% or less in order not to allow the plate thickness of the internal side of the plate to be too thick with respect to the average plate thickness. In the aforementioned cold rolling process, the a-value and the pc-value can be controlled to be the desired values by controlling the flexible shape of the cold rolling.

a=h/c

pc=c/tc×100 (%)

h: Difference between plate thickness of ear section and minimum plate thickness

c: Difference between maximum plate thickness at the central section and minimum plate thickness

tc: Maximum plate thickness at the central section

Note that these values can be more easily understood by referring to FIG. 2 in JP 11-254847 A.

In addition, it is preferable that in the present invention, bending per the length of the aluminum plate 4 m is 0.3 mm or less. If the bending of the aluminum plate is big, a winding shift gradually becomes big as winding is performed. If the aluminum plate is wound as a coil, breaking or distortion at the plate end section attributable to winding shift occurs. The target value of the aforementioned bending can be achieved by controlling the parallelism of the cold rolling roll and the sending accuracy of the aluminum plate by a cold rolling mill.

In addition, it is preferable that in the present invention, the height of burr at the plate end is 10 μm or less. If the burr at the end section is high, plastic deformation is likely to take place at the end section while the aluminum plate wound as a coil is stored due to the same reason as in the description of the sectional shape. In addition, in the surface treatment for obtaining a support for a lithographic printing plate or the image recording layer coating process for preparing a presensitized plate, the burr is not preferable since the burr is likely to scratch presensitized plate manufacturing equipment such as a path roll and a coating device. Therefore, it is preferable that the height of the burr is determined to be 10 μm or less as mentioned above. The height of the burr can be controlled to be 10 μm or less by controlling the clearance of a blade in a slitter process where the ear section of a coil is cut off.

In addition, in order to machine the plate into a predetermined plate width, the plate is usually allowed to pass through a slitter line. Either a shear plane or a fracture plane or both occur at an end of the plate which is cut by the slitter when the end of the plate is cut off by a slitter blade.

It is preferable that in the present invention, the thickness of the aluminum plate is selected in a range of 0.10 to 0.50 mm, and that for the accuracy, the plate thickness difference over the entire length of the coil is within 20 μm, and more preferable is within 12 μm. In addition, it is preferable that the plate thickness difference in the width direction is within 6 μm, and more preferable is within 3 μm. Moreover, it is preferable that the accuracy of the plate width is within 2.0 mm, and more preferable is within 1.0 mm.

Although the surface roughness of the aluminum plate is likely to be affected by that of the reduction roll, it is preferable that the aluminum plate is finished so as to finally allow arithmetic average roughness Rₐ to be about 0.1 to 1.0 μm. If Rₐ is too large, it is not preferable in appearance of the plate since the roughness of the aluminum plate from the beginning, that is, the rough rolling streak transferred by the reduction roll can be observed from above the image recording layer in the presensitized plate. It is not industrially preferable that Rₐ is determined to be 0.1 μm or less since it is necessary to finish the surface of the reduction roll at excessively low roughness.

In addition, in order to prevent the occurrence of scratches caused by the friction of aluminum plates to each other, a thin oil film may be provided on the surface of the aluminum plates. As an oil film, a volatile one or a non-volatile one is suitably used, if necessary. Since a slipping fault may occur on the manufacturing line if the oil quantity is too much, it is preferable that the oil quantity is 100 mg/m² or less, more preferable is 50 mg/m² or less, and still more preferable is 10 mg/m² or less. In addition, scratches may occur while the coil is transferred if no oil is provided, it is preferable that the oil quantity is 3 mg/m² or more.

In case of the continuous casting, if, for example, the casting is performed by the method using cooling rolls such as Hunter method (twin-roll method), a cast plate with plate thickness of 1 to 10 mm can be directly and continuously cast and rolled, the method has a merit to omit the hot rolling process. In addition, according to the method using cold belts such as Huzley method (two-belt method), a cast plate with plate thickness of 10 to 15 mm can be cast, and generally, a continuously cast rolled plate with plate thickness of 1 to 10 mm can be obtained by continuously rolling the plate using a hot reduction roll immediately after casting.

The continuously cast rolled plate obtained by these methods can be finished into a predetermined plate thickness of 0.10 to 0.50 mm through the processes such as cold rolling, intermediate annealing, improvement of planarity and slit as described in DC casting. For-the conditions of intermediate annealing and cold rolling if the continuous casting method is used, for example, the methods described in JP 6-220593 A, JP 6-210308 A, JP 7-54111 A and JP 8-92709 A.

<Graining Treatment>

Graining treatments including electrochemical graining treatment are performed on the aforementioned aluminum plate. Since, in the present invention, the aluminum alloy plate contains the specified elements of the specified quantity as described above, uniform and very fine pits can be formed by electrochemical graining treatment. As a result, sensitivity is excellent, adhesion between the image recording layer and the support is more improved, press life (cleaner press life) is improved and scum resistance is also improved. Even if the presensitized plate for a laser printing plate is prepared by providing a laser directly-drawn image recording layer using the support for a lithographic printing plate according to the present invention, the adhesion between the image recording layer and the support can be improved. In addition, even if Si atom adhesion quantity is determined to be 0.1 to 30 mg/m² and the presensitized plate is prepared by providing the image recording layer thereon, the adhesion between the image recording layer and the support can be improved.

Electrochemical graining treatment usually performed by applying DC current or AC current between the aluminum plate and an electrode opposite thereto and by using an acid of nitric acid, hydrochloric acid or the like as an electrolytic solution. In AC electrolysis, a commercial AC sinusoidal wave (sine wave) current, a special alternating current, a rectangular current or the like can be used. It is preferable that the concentration of the electrolytic solution is 1 to 300 g/L. An element required to stabilize electrochemical graining treatment can be suitably added in the form of an ion to an electrolytic solution of nitric acid, hydrochloric acid or the like.

Crater-shaped or honeycomb-shaped pits can be produced on the surface of the aluminum alloy plate at the area rate of 30 to 100% (dispersion density) by electrochemical graining treatment.

In the present invention, by controlling the content of Cu in the aluminum alloy, the average diameter of pits produced by nitric acid electrolysis (electrochemical graining treatment in a nitric acid aqueous solution) can be 1.5 μm or more, water retention property can be improved, thereby scum resistance can be improved.

In addition, in the present invention, since, by controlling the content of Cu in the aluminum alloy, the diameter of a pit produced by hydrochloric acid electrolysis (electrochemical graining treatment in a hydrochloric aqueous solution) can be 0.5 μm or less as a circle equivalent diameter and can be preferably 0.3 μm or less, and formed pits of 10% or more can be an approximate square or a rectangle to thereby increase the surface area of the aluminum plate, the adhesion with the image recording layer can be improved.

It is preferable that for the quantity of electricity used for electrochemical graining treatment in case of nitric acid electrolysis, the total quantity of electricity in anodic reaction is 50 to 400 C/dm², and more preferable is 100 to 300 C/dm².

It is preferable that hydrochloric acid electrolysis is performed after nitric acid electrolysis, and that the total quantity of electricity in anodic reaction is 10 to 100 C/dm², and more preferable is 30 to 80 C/dm².

It is preferable that in the present invention, electrochemical graining treatment is combined with other graining treatments. Other graining treatments include, for example, mechanical graining treatment, chemical graining treatment or the like.

It is preferable that as graining treatments, graining treatment is performed in the order of mechanical graining treatment, nitric acid electrolytic graining and hydrochloric acid graining.

Note that it is preferable that after each graining treatment, the chemical etching treatment mainly consisting of an alkali solution is performed to remove sharp areas, desmutting treatment mainly consisting of an acid solution is performed to remove products produced by the chemical etching treatment.

These graining treatments can be each performed with the methods generally used.

The measurement methods of pit shapes formed by nitric acid electrolysis, hydrochloric acid electrolysis or the like are as follows:

The surface of the support is photographed right overhead at 50,000-fold magnification with a high resolution scanning electron microscope (FESEM) and the total number of pits whose average a circle equivalent diameter of 0.5 μm or less is counted in the obtained SEM micrograph.

Next, in the SEM micrograph, a non-round pit whose radius of curvature (R) at an angular section is one-fourth the size of the a circle equivalent diameter of the pit or less is determined to be an approximate square or a rectangle, and the number of the pits are counted. The number of the pits with an approximate square or rectangle is divided by the total number of the pits with an average a circle equivalent diameter of 0.5 μm or less to calculate the rate of the pits with an approximate square or rectangle.

<Anodizing Treatment>

It is preferable that anodizing treatment is performed to increase abrasion resistance of the surface of the aluminum plate following graining treatment. An electrolyte used for anodizing treatment may be any electrolyte which could form porous anodizing layers. Sulfuric acid, phosphoric acid, oxalic acid, chromic acid or these mixtures are generally used. The concentration of the electrolyte is suitably determined depending upon the kind of the electrolyte or the like. Although the conditions of anodizing treatment are hardly specified since they largely vary with electrolytes, the conditions may be generally that the concentration of the electrolyte is 1 to 80 wt %, the temperature of the electrolyte is 5 to 70° C., the current density is 1 to 60A/dm², the voltage is 1 to 100V and the electrolysis time is 10 to 300 sec.

<Treatment for Water Wettability>

As mentioned above, for the aluminum plate on which graining treatment is performed, preferably anodizing treatment is further performed, treatment for water wettability is still further performed by using an aqueous solution containing an alkali metal silicate. Although various methods conventionally known can be used as a treatment for water wettability with an alkali metal silicate, it is preferable that the adhesion quantity of the alkali metal silicate to the surface of the support is set in a predetermined range.

It is preferable that in the present invention, the Si atom converted adhesion quantity of the alkali metal silicate to the surface of the support for a lithographic printing plate (Si atom adhesion quantity) is 0.1 mg/m² or more, and more preferable is 2.0 mg/m² or more. If the Si atom adhesion quantity is less than 0.1 mg/m², one or more of sensitivity, cleaner press life and scum resistance or more may deteriorate. In addition, since water wettability is increased in the non-image areas of a lithographic printing plate, if development is performed by using a developer containing an alkali metal silicate, a solid substance attributable to SiO₂ may be deposited, the non-image areas may be whitened at the time of development or scum or slime may be produced at the time of development.

On the other hand, it is preferable that in the present invention, Si atom adhesion quantity is 30 mg/m2 or less, and further preferable is 20 mg/m² or less, and still more preferable is 10 mg/m2 or less. If Si atom adhesion quantity exceeds 30 mg/m², press life may be inferior.

In the present invention, the adhesion quantity of an alkali metal silicate to the surface of the support for a lithographic printing plate uses a value measured as Si atom adhesion quantity (Si mg/m²) with a calibration curve method using X-ray Flourescence Spectrometer (XRF). As a standard specimen for preparation of the calibration curve, after a sodium silicate aqueous solution containing the already known Si atom quantity is uniformly dropped in an area of 30 mmΦ on an aluminum plate, the specimen which is dried is used. Models of the X-ray Flourescence Spectrometer and other conditions are not particularly limited. One example of the conditions of X-ray Flourescence Spectrometry of Si is described below.

X-ray Flourescence Spectrometer: RIGAKU Corporation—made RIX3000, X-ray lamp: Rh, Measurement spectrum: Si—Kα, Lamp voltage: 50 kV, Lamp current: 50 mA, Slit: COARSE, Analyzing crystal: RX4, Detector: F-PC, Analyzed area: 30 mmΦ, Peak position (2θ): 144.75 deg., Background (28): 140.70 deg. and 146.85 deg., Elapsed time: 80 sec./sample

Treatment for water wettability can be performed, for example, by dipping the support for a lithographic printing plate on which anodizing treatment has been performed into the aqueous solution containing an alkali metal silicate where the concentration of an alikali metal silicate is 0.001 to 30 wt %, preferably 0.01 to 10 wt %, more preferably 0.1 to 5 wt % and pH is 10 to 13 at 25° C. at 4 to 40° C. for 0.5 to 120 sec., and preferably 2 to 30 sec. The treatment conditions such as the aforementioned concentration of the alkali metal silicate, pH, temperature of the aqueous solution and treatment time can be properly selected so as to allow Si atom adhesion quantity to be the aforementioned specified quantities. If pH of the aqueous solution containing an alkali metal silicate is less than 10, the solution is likely to be gelled. In addition, it is necessary to use care that pH higher than 13.0 may cause the anodizing layers to be dissolved.

The alkali metal silicates used for treatment for water wettability include, for example, sodium silicate, potassium silicate and lithium silicate.

In the treatment for water wettability, a hydroxide can be blended to control pH of the aqueous solution containing an alkali metal silicate at a high level if required. The hydroxides include, for example, sodium hydroxide, potassium hydroxide and lithium hydroxide.

In addition, an alkaline earth metal salt and/or 4 group (IVA group) metal salt may be blended in the aqueous solution containing an alkali metal silicate aqueous solution if required. Alkaline earth metal salts include, for example, water-soluble salts of nitrates of alkaline earth metals (for example, calcium nitrate, strontium nitrate, magnesium nitrate, barium nitrate), sulfate, hydrochloride, phosphate, acetate, oxalate, borate or the like. The 4 group (IVA group) metal salts include, for example, titanium tetrachloride, titanium trichloride, potassium titanium fluoride, potassium titanium oxalate, titanium sulfate, titanium tetraiodide, zirconium chloride oxide, zirconium dioxide, zirconium oxychloride and zirconium tetrachloride. Alkaline earth metal salts and 4 group (IVA group) metal salt may be each used singly or two kinds or more of combinations may be used. The usage of these metal salts are preferably 0.01 to 10 wt %, and more preferably 0.05 to 5.0 wt %.

[Presensitized Plate]

<Undercoat>

In the present invention, for example, inorganic undercoats such as water-soluble metal salts, e.g. zinc borate, or organic undercoats may be provided as required before a photosensitive layer is provided on an aluminum support for a lithographic printing plate according to the present invention thus obtained.

Taken up as organic compounds used for an organic undercoat for example are carboxymethylcellulose; dextrin; gum arabic; polymer or copolymer having sulfo group at side chain; polyacrylic acid; phosphonic acids having amino groups such as 2-aminoethyl phosphonic acid; organic phosphonic acids such as phenylphosphonic acid, naphthylphosphonic acid, alkylphosphonic acid, glycerophosphonic acid, methyldisuphosphonic acid and ethylenediphosphonic acid which may have a substituent; organic phosphoric acids such as; phenylphosphoric acid, naphthylphosphoric acid, alkylphosphoric acid and glycerophosphoric acid which may have a substituent; organic phosphinic acids such as phenylphosphinic acid, naphthylphosphinic acid, alkylphosphinic acid and glycerophosphinic acid which may have a substituent; amino acids such as glycine and β-alanine; amine hydrochlorides having hydroxy groups such as triethanolamine hydrochlorides; yellow dyes. For these compounds, either they may be singly used or a combination of two kinds or more may be used.

An organic undercoat is provided by dissolving the above organic compound in water or organic solvents such as methanol, ethanol, methylethylketone or their mixed solvent, applying the solvent to an aluminum plate and drying the solvent. It is preferred that the concentration of a solution dissolving the organic compound is 0.005 to 10 wt %. A coating method is not particularly limited and any of bar coater coating, rotary coating, spray coating, curtain coating and the like can be used.

It is preferred that the coated quantity after an organic undercoat is dried is 2 to 200 mg/m² and more preferred is 5 to 100 mg/m². If the coated quantity remains within the above range, press life becomes better.

<Image Recording Layer>

A support for a lithographic printing plate according to the present invention can be provided with an image recording layer to prepare a presensitized plate according to the present invention. A photosensitive composition is used for the image recording layer.

Taken up as photosensitive compositions suitably used for the present invention for example are a photosensitive composition of the thermal positive type containing an alkali-soluble high-molecular compound and a photothermal conversion agent (hereinafter referred to as “thermal positive type” with regard to this composition and an image recording layer using the same), a photosensitive composition of the thermal negative type containing a curable compound and a photothermal conversion agent (hereinafter similarly referred to as “thermal negative type”), a photosensitive composition of the photopolymerization type (hereinafter similarly referred to as “photopolymer type”), a photosensitive composition of the negative type containing diazo resin or photo cross-linkable resin (hereinafter similarly referred to as “conventional negative type”), a photosensitive composition of the positive type containing a quinonediazide compound (hereinfater similarly referred to as “conventional positive type”) and a photosensitive composition dispensing with an independent development (hereinafter similarly referred to as “development-dispensable type”). Below described are these suitable photosensitive compositions.

<Thermal Positive Type>

<Photosensitive Layer>

A photosensitive composition of the thermal positive type contains an alkali-soluble high-molecular compound and a photothermal conversion agent. In a image recording layer of the thermal positive, the photothermal conversion agent converts the exposure energy of infrared ray laser and the like into heat, which efficiently cancels an interaction lowering the alkali-solubility of an alkali-soluble high-molecular compound.

Taken up as alkali-soluble high-molecular compound for example are a resin containing an acid group in a molecule and a mixture of two kinds or more of the resin. Particularly preferred is a resin having acid groups such as a phenolic hydroxy group, sulfonamide group (—SO₂ NH—R (where, R represents a hydrocarbon group)), and active imino group (—SO₂ NHCOR, —SO₂ NHSO₂ R or —CONHSO₂R (where, R has the similar meaning to the above.)) from the view point of the solubility of the resin to an alkali developer.

Above all, the resin having the phenolic hydroxy group is preferable since it is excellent in image-forming capability in the exposure by an infrared ray laser or the like. For example, novolac resins such as phenol-formaldehyde resin, m-cresol-formaldehyde resin, p-cresol-formaldehyde resin, m-/p-mixed cresol-formaldehyde resin and phenol/cresol (any of m-, p- and m-/p-mixed may be allowed) -mixed-formaldehyde resin (phenolcresolformaldehyde cocondensation resin), are preferably cited. More specifically, polymers described in JP 2001-305722 A (particularly, [0023] to [0042]), polymers containing a repeating unit expressed by a general formula (1) as described in JP 2001-215693 A and polymers as described in JP 2002-311570 A (particularly, [0107]) are preferably used.

As the photothermal conversion agent, from a viewpoint of a recording sensitivity, pigment or dye, which has a light absorbing band in the infrared band ranging from 700 to 1200 nm in wavelength, is preferable. Concretely cited as the dye are azo dye, azo dye in the form of metallic complex salt, pyrazolone azo dye, naphthoquinone dye, anthraquinone dye, phthalocyanine dye, carbonium dye, quinonimine dye, methine dye, cyanine dye, squarylium dyestuff, pyrylium salt, metal thiolate complex (for example, nickel thiolate complex) and the like. Particularly, the cyanine dye is preferable and, for example, the cyanine dye represented by the general formula (I) in JP 2001-305722 A is cited.

A dissolution inhibitor can be contained in the photosensitive composition of the thermal positive type. Suitably taken up as a dissolution inhibitor is one as described in [0053] to [0055] of JP 2001-305722 A.

In addition, it is preferred that a sensitivity regulator, a printing agent to obtain an visible image just after heated by exposure, compounds such as dyes as colorant and a surfactant to improve coating property and treatment stability are contained in the photosensitive composition of the thermal positive type as additives. Compounds as described in [0056] to [0060] of JP 2001-305722 A are preferred for these compounds.

Besides the foregoing aspects, suitably used are photosensitive compositions as described in 2001-305722 A.

In addition, the image recording layer of the thermal positive type may be either a single layer or a two-layer structure.

Suitably taken up as the image recording layer of a two-layer structure (image recording layer of superimposed-type) is a type where a lower layer (hereinafter referred to as “A layer”) excellent in press life and solvent resistance is provided on the side closer to the support and a layer (hereinafter referred to as “B layer”) excellent in an image-forming capability of positive type is provided on the A layer. This type is of high sensitivity and can realize a broader development latitude. The B layer generally contains a photothermal conversion agent. The above-mentioned dyes are suitably taken up as photothermal conversion agents.

Suitably taken up as resins used for the A layer is a polymer which includes a monomer having sulfonamide group, active imino group, phenolic hydroxy group and the like as a copolymerization component since the polymer is excellent in press life and solvent resistance. Suitably taken up as resins used for the B layer is a resin soluble in an alkali aqueous solution having a phenolic hydroxy group.

Various additives can be contained in compositions used for the A and B layers as required besides the aforementioned resins. Concretely, suitably used are various additives as described in [0062] to [0085] of JP 2002-323769 A. In addition, also suitably used are additives as described in [0053] to [0060] of JP 2001-305722 A as aforementioned.

It is preferred that for each component and its content included in the A layer or the B layer, what is described in JP 11-218914 A is followed.

<Intermediate Layer>

It is preferred that an intermediate layer is provided between the image recording layer of the thermal positive type and the support. Suitably taken up as components contained in the intermediate layer are various organic compounds as described in [0068] of JP 2001-305722 A.

<Others>

A method for preparing the image recording layer of the thermal positive type and a method for making a plate can use a method as detailedly described in JP 2001-305722 A.

<Thermal Negative Type>

A photosensitive composition of the thermal negative type contains a curable compound and a photothermal conversion agent. An image recording layer of the thermal negative type is a photosensitive layer of the negative type where areas irradiated by an infrared ray laser or the like are cured to form image areas.

<Polymerizable Layer>

An image recording layer of the polymerizable-type (polymerizable layer) is suitably taken up as the image recording layer of the thermal negative type. The polymerizable layer contains a photothermal conversion agent, a radical generator, a radical polymerizable compound which is a curing compound and a binder polymer. In the polymerizable layer, the infrared rays absorbed by a photothermal conversion agent are converted into heat, which decomposes a radical generator to generate radicals, which allows a radical polymerizable compound to continuously polymerize and a radical polymerizable compound cure.

Taken up as a photothermal conversion agent for example is a photothermal conversion agent contained in the aforementioned the thermal positive type. Taken up as a concrete example of cyanine dye stuff which is particularly preferred are those as described in [0017] to [0019] of JP 2001-133969 A.

Onium salts are suitably taken up as radical generators. Particularly preferred are onium salts as described in [0030] to [0033] of JP 2001-133969 A.

Taken up as a radical polymerizable compound is a compound having at least one, and preferably two or more of the ethylenically unsaturated end bondings.

A linear organic polymer is suitably taken up as a binder polymer. Suitably taken up is a polymer which is soluble or swellable in water or alkalescent aqueous water. Among them, a (meth)acryl resin having unsaturated groups such as allyl group and acryloyl group or benzyl group, and carboxy group at side chain is suitable since the resin is excellent in a balance of layer strength, sensitivity and development property.

For a radical polymerizable compound and a binder polymer, those as detailedly described in [0036] to [0060] of JP 2001-133969 A can be used.

It is preferred that additives (for example, a surfactant to improve coating property) as described in [0061] to [0068] of JP 2001-133969 A are contained in a photosensitive composition of the thermal negative type.

For a method for preparing the polymerization layer and a method for making a plate, the methods as detailedly described in JP 2001-133969 A can be used.

<Acid Cross-Linkable Layer>

An image recording layer of acid cross-linkable type (acid cross-linkable layer) is suitable taken up also as one of the image recording layers of the thermal negative type. The acid cross-linkable layer contains a photothermal conversion agent, an acid generator by heat, a compound which is cross-linked by an acid that is a curable compound (cross-linking agent) and an alkali-soluble high-molecular compound which may react with a cross-linking agent under the presence of an acid. In the acid cross-linkable layer, infrared rays absorbed by the photothermal conversion agent are converted into heat, which decomposes the acid generator by heat to generate an acid, which allows the cross-linking agent to react with the alkali-soluble high-molecular compound and cure.

The same photothermal conversion agents as used in the polymerizable layer are taken up at this stage.

Taken up as acid generator by heat for example are decomposable compounds by heat such as a photoinitiator for the photopolymerization, a color-turning agent (i.e., dye stuff) and an acid generator for use in micro resist.

Taken up as cross-linking agents for example are aromatic compounds substituted with a hydroxymethyl group or an alkoxymethyl group; compounds having a N-hydroxymethyl group, a N-alkoxymethyl group or a N-acyloxymethyl group; and expoxy compound.

Taken up as an alkali-soluble high-molecular compound for example are novolak resin and polymer having hydroxyaryl group at side chain.

<Photopolymer Type>

A photopolymerization type photosensitive composition contains an addition polymerizable compound, a photopolymerization initiator and a high-molecular binding agent.

Suitably taken up as the addition polymerizable compound is a compound containing ethylenically unsaturated bonding capable of addition polymerization. The compound containing ethylenically unsaturated bonding is a compound having an ethylenically unsaturated end bonding. Concretely, it has a chemical form of monomer, prepolymer, mixtures of these or the like for example. Taken up as examples of the monomer are an ester of an unsaturated carboxylic acid (for example, acrylic acid, methacrylic acid, itaconic acid and maleic acid) and an aliphatic polyalcohol compound and the amide of an unsaturated carboxylic acid and an aliphatic polyamine compound.

In addition, a urethane type addition polymerizable compound is suitably taken up also as an addition polymerizable compound.

As the photopolymerization initiator, a variety of photopolymerization initiators or combined systems of two or more photopolymerization initiators (photo initiation systems) can be appropriately selected for use. For example, initiation systems described in [0021] to [0023] of JP 2001-22079 A are preferable.

Since the high-molecular binding agent needs not only to function as a coating layer forming agent for the photopolymerization type photosensitive composition but also to dissolve the photosensitive layer in an alkali developer, an organic high-molecular polymer that is soluble or swellable in an aqueous solution of alkali is used. As the above-described high-molecular binding agent, the agents described in [0036] to [0063] of JP 2001-22079 A are preferred.

It is preferable to add the additive described in [0079] to [0088] of JP 2001-22079 A (for example, a surfactant for improving the coating property, a colorant, a plasticizer, and a thermal polymerization inhibitor) to the photopolymerization type photosensitive composition of the photopolymer type.

Moreover, it is also preferable to provide an oxygen-shieldable protective layer on the above-described image recording layer of the photopolymer type for preventing the polymerization inhibiting action of oxygen. For example, poly(vinyl alcohol) and a copolymer thereof are cited as a polymer contained in the oxygen-shieldable protective layer.

Furthermore, it is also preferable that an intermediate layer or adhesive layer as described in [0124] to [0165] of JP 2001-228608 A is provided.

<Conventional Negative Type>

A photosensitive composition of the conventional negative type contains diazo resin or photo closs-linkable resin. Among them, a photosensitive composition containing diazo resin and a high-molecular compound that is soluble or swellable in alkali is suitably cited.

Cited as such diazo resin is, for example, a condensate of an aromatic diazonium salt and a compound containing an active carbonyl group such as formaldehyde, and an inorganic salt of diazo resin soluble in organic solvents, which is a reaction product of a condensate of p-diazo phenyl amines and formaldehyde with hexafluorophosphate or tetrafluoroborate. Particularly, a high-molecular diazo compound containing 20 mol % or more of a hexamer or larger, which is described in JP 59-78340 A, is preferable.

For example, copolymer containing, as an essential component, acrylic acid, methacrylic acid, crotonic acid or maleic acid is cited as a binding agent. Specifically, multi-copolymer of monomer such as 2-hydroxyethyl(meth)acrylate, (meth)acrylonitrile and (meth)acrylic acid, which is as described in JP 50-118802 A, and multi-copolymer composed of alkylacrylate, (metha)acrylonitrile and unsaturated carboxylic acid, which is as described in JP 56-4144 A, are cited.

Furthermore, to the photosensitive composition of the conventional negative type, it is preferable to add a compound such as a printing agent, a dye, a plasticizer for imparting the flexibility and abrasion resistance of the coating layer, a compound such as a development accelerator, and a surfactant for improving the coating property, which are described in [0014] and [0015] of JP 7-281425 A.

It is preferable that an intermediate layer containing a high-molecular compound having a constituent with an acid group and a constituent with an onium group, which is described in JP 2000-105462 A, is provided under the photosensitive layer of the conventional negative type.

<Conventional Positive Type>

As a photosensitive composition of the conventional positive type contains quinonediazide compound. Among them, the photosensitive composition containing an o-quinonediazide compound and alkali-soluble high-molecular compound is suitably cited.

Cited as such an o-quinonediazide compound are, for example, an ester of 1,2-naphthoquinone-2-diazide-5-sulfonyl chloride and phenol-formaldehyde resin or cresol-formaldehyde resin, and an ester of 1,2-naphthoquinone-2-diazide-5-sulfonyl chloride and pyrogallol-acetone resin, which is described in U.S. Pat. No. 3,635,709.

Cited as such an alkali-soluble high-molecular compound are, for example, phenol-formaldehyde resin, cresol-formaldehyde resin, phenol-cresol-formaldehyde co-condensed resin, polyhydroxystyrene, copolymer of N-(4-hydroxyphenyl)methacrylamide, carboxy group-containing polymer described in JP 7-36184 A, acrylic resin containing a phenolic hydroxy group as described in JP 51-34711 A, acrylic resin containing a sulfonamide group described in JP 2-866 A, and urethane resin.

Furthermore, it is preferable that a compound such as a sensitivity regulator, a printing agent and a dye, which are described in [0024] to [0027] of JP 7-92660 A, or a surfactant for improving a coating property, which is as described in [0031] of JP 7-92660 A, is added to the photosensitive composition of the conventional positive type.

It is preferred that an intermediate layer which is the same layer suitably used for the conventional negative type is provided under photosensitive layer of the conventional positive type.

<Development-Dispensable Type>

Taken up as a photosensitive compositions of the development-dispensable type are a thermoplastic particle polymer type, a microcapsule type, a type containing sulfonic acid-generating polymer and the like. These are all thermosensitive types containing photothermal conversion agents. It is preferred that a photothermal conversion agent is the same dye as used for the aforementioned thermal positive type.

A photosensitive composition of the thermoplastic particle polymer type is a composition in which hydrophobic thermowelding resin particle polymers are dispersed in a hydrophilic polymer matrix. In an image recording layer of the thermoplastic particle polymer type, a hydrophobic thermoplastic particle polymers are welded by a heat generated by exposure and these are welded and adhered to each other to form a hydrophobic area, namely, an image area.

It is preferred that the particles are welded and mutually fuse by heat and more preferred the particle polymers are one that the surface of the particle polymers is hydrophilic and the particle polymers can be dispersed in hydrophilic components such as fountain solution. Concretely, suitably taken up are thermoplastic particle polymers as described in Research Disclosure No.33303 (Published in January, 1992), JP 9-123387 A, JP 9-131850 A, JP 9-171249 A, JP 9-171250 A and EP 931,647 A. Preferred are polystyrene and poly methyl methacrylate among them. Taken up as particle polymers having a hydrophilic surface for example are ones that polymers per se are hydrophilic; and polymers with the surface made hydrophilic by allowing hydrophilic compounds such as poly (vinyl alcohol) and polyethylene glycol to be adsorbed to the surface of a particle polymer.

Preferred is a particle polymer having a reactive functional group.

As a photosensitive composition of the microcapsule type, one described in JP 2000-118160 A and a microcapsule type containing a compound having a thermoreactive functional group as described in JP 2001-277740 A are preferably cited.

As a sulfonic acid-generating polymer for use in a photosensitive composition of the type containing the sulfonic acid-generating polymer, for example, polymer having a sulfonic acid ester group, a disulfonic group or a sec- or tert-sulfonamide group in the side chain described in JP 10-282672 A is cited.

The hydrophilic resin can be contained in the thermosensitive layer of the development-dispensable type, and thus, not only the on-machine development property would be improved, but also the coating layer strength of the thermosensitive layer itself would be improved. Preferred as hydrophilic resins are, for example, resins having hydrophilic groups such as hydroxy group, carboxy group, hydroxyethyl group, hydroxypropyl group, amino group, aminoethyl group, aminopropyl group and carboxymethyl group and hydrophilic sol-gel conversion type binding resins.

The image recording layer of the development-dispensable type dispenses with an independent development process and development processing can be performed on a printing press. For a method for preparing the image recording layer of the development-dispensable type and a method for making plate and printing, the methods as detailedly described in JP 2002-178655 A can be used.

<Backcoat Layer>

On the reverse side of the presensitized plate of the present invention, which is obtained by providing various types of image recording layers on the support for the lithographic printing plate of the present invention, a backcoat layer composed of an organic high-molecular compound can be provided according to needs in order to prevent the image recording layers from being scratched in the case of stacking the presensitized plate or the like.

<Method of Producing a Presensitized Plate>

Usually, the respective layers of the image recording layer and the like can be produced by coating a coating liquid obtained by dissolving the foregoing components into a solvent on the support for the lithographic printing plate.

Cited as solvents used herein are ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolan, γ-butyrolactone, toluene, water and the like. However, the present invention is not limited to this. These solvents are used singly or mixedly.

It is preferable that the concentration of the foregoing components (entire solid part) in the solvent range from 1 to 50 wt %.

Various coating methods can be used. For example, bar coater coating, rotation coating, spray coating, curtain coating, dip coating, air knife coating, blade coating, roll coating and the like can be cited.

<Method of Producing a Lithographic Printing Plate>

The presensitized plate of the present invention is made into a lithographic printing plate by various treatment methods in accordance with the kind of the image recording layer.

Cited as light sources of active rays for use in the image exposure are, for example, a mercury lamp, a metal halide lamp, a xenon lamp and a chemical lamp. As laser beams, for example, helium-neon (He—Ne) laser, argon laser, krypton laser, helium-cadmium laser, KrF excimer laser, semiconductor laser, YAG laser and YAG-SHG laser are cited.

If after the exposure is performed, an image recording layer is either of the thermal positive type, the thermal negative type, the conventional negative type, the conventional positive type or the photopolymer type, it is preferred that a lithographic printing plate is obtained by performing development treatment using a developer after exposure is performed.

It is preferred that a developer is an alkali developer and more preferred is an alkaline aqueous water substantially containing no organic solvent.

In addition, also preferred is a developer substantially containing no alkali metal silicates and containing saccharides (a developer substantially containing no an alkali metal silicate). For a method for performing development treatment using a developer substantially containing no an alkalibmetal silicate, the method as detailedly described in JP 11-109637 A can be used.

In addition, a developer containing an alkali metal silicate can be also used.

If the treatment method of a presensitized plate where development is performed by using a developer substantially containing no alkali metal silicate is used, the method can prevent such problems as that development is performed by using a developer containing an alkali metal silicate, that is, what a solid substance attributable to SiO₂ is likely to deposit and as that a gel attributable to SiO₂ is produced in a neutralization treatment when a waste developer is treated.

The presensitized plate according to the present invention by providing an image recording layer on the support for a lithographic printing plate using the aforementioned aluminum plate according to the present invention is excellent in sensitivity, cleaner press life, scum resistance and press life when a lithographic printing plate is prepared.

In addition, the support for a lithographic printing plate using the aluminum plate according to the present invention and the presensitized plate using the same are excellent in all of sensitivity, cleaner press life, scum resistance and press life when a lithographic printing plate is prepared and are also excellent in mechanical strength. Furthermore, the support for a lithographic printing plate using the aluminum plate according to the present invention and the presensitized plate using the same are also excellent in surface quality (external appearance), besides the aforementioned characteristics.

Moreover, the presensitized plate according to the present invention by providing a laser exposed-type image recording layer on the support for a lithographic printing plate using the aluminum plate according to the present invention is excellent in all of sensitivity, cleaner press life, press life and scum resistance and can be treated with a developer containing no alkali metal silicate.

### EXAMPLES

Although the present invention is described in detail by showing Examples below, the present invention is not limited to these Examples.

### Examples 1 to 10 and Comparative Examples 1 to 3

1. Preparation of Support for Lithographic Printing Plate

<Aluminum Plate>

The metal component alloy shown in Table 1 was DC-cast, after facing was performed on the ingot, the aluminum plate was obtained by sequentially performing soaking treatment, hot rolling, intermediate annealing and cold rolling.

For more detail, a molten metal was prepared by using an aluminum alloy comprising the metal components shown in Table 1 and the remaining portion containing aluminum and unavoidable impurities, and after a molten treatment and filtration were performed, an ingot with thickness of 500 mm and width of 1,200 mm was prepared with DC casting. After the surface of the ingot was scraped off by an average of 10 mm with a facing attachment, the ingot was soaked and held at 550° C. for about 5 hours, when the temperature dropped to 400° C., a rolled plate with the plate annealing thickness (Annealed plate thickness) shown in Table 1 was prepared with a hot rolling mill. Furthermore, after thermal treatment was performed at 500° C. with a continuous annealer, the plate was finished with the plate thickness t shown in Table 1 by cold rolling, and after the width of the aluminum plate was controlled to 1,030 mm, the aluminum plate was subjected to the following surface treatments.

The plate thicknesses t of each aluminum plate were controlled to a predetermined plate thickness by changing the draft in the final rolling (cold rolling).

In addition, the sizes of the crystal grains in the aluminum plate were controlled by changing the trace metal components shown in Table 1 and the plate thickness of the aluminum plate on which the intermediate annealing was performed and the final rolling conditions.

Concretely, AL 1 to 7 was prepared by changing the trace metal components shown in Table 1. The same trace metal components for AL 8 to 13 were kept, AL 8 was prepared by changing the plate thickness of the aluminum plate on which the intermediate annealing was performed-and AL 9 to 13 were prepared by changing the final rolling condition (plate thickness).

TABLE 1

| | Plate | | | | | Annealed | Tensile | Relation | Intermetallic | | | | | |
|---|---|---|---|---|---|---|---|---|---|---|---|---|---|---|
| | thick- | Metal component | | | | plate | strength | of | compound | | Crystal grain | | Length of | |
| Aluminum | ness t | (content: wt %) | | | | thickness | TS | equation | Pieces | Occupation | width (μm) | | crystal grain (μm) | |
| Plate | (mm) | Fe | Si | Cu | Ti | (mm) | (Mpa) | [1] | (pcs/mm²) | rate (%) | Average | Maximum | Average | Maximum |
| AL-1 | 0.3 | 0.29 | 0.08 | 0.025 | 0.01 | 1.5 | 155 | ◯ | 4500 | 90 | 45 | 75 | 300 | 380 |
| AL-2 | 0.3 | 0.29 | 0.08 | 0.020 | 0.01 | 1.5 | 152 | ◯ | 4000 | 90 | 40 | 65 | 300 | 370 |
| AL-3 | 0.3 | 0.29 | 0.08 | 0.030 | 0.01 | 1.5 | 161 | ◯ | 4500 | 90 | 45 | 100 | 320 | 390 |
| AL-4 | 0.3 | 0.29 | 0.08 | 0.040 | 0.01 | 1.5 | 165 | ◯ | 5500 | 90 | 49 | 130 | 380 | 410 |
| AL-5 | 0.3 | 0.35 | 0.08 | 0.025 | 0.01 | 1.5 | 160 | ◯ | 6500 | 90 | 42 | 70 | 300 | 380 |
| AL-6 | 0.3 | 0.29 | 0.08 | 0.018 | 0.01 | 1.5 | 154 | ◯ | 4000 | 90 | 38 | 60 | 290 | 360 |
| AL-7 | 0.3 | 0.29 | 0.08 | 0.053 | 0.01 | 1.5 | 169 | ◯ | 5800 | 85 | 60 | 140 | 400 | 490 |
| AL-8 | 0.3 | 0.29 | 0.08 | 0.025 | 0.01 | 0.5 | 135 | X | 6000 | 83 | 85 | 170 | 450 | 520 |
| AL-9 | 0.24 | 0.29 | 0.08 | 0.025 | 0.01 | 1.5 | 161 | ◯ | 4500 | 88 | 42 | 80 | 350 | 440 |
| AL-10 | 0.2 | 0.29 | 0.08 | 0.025 | 0.01 | 1.5 | 165 | ◯ | 4500 | 92 | 47 | 73 | 370 | 460 |
| AL-11 | 0.15 | 0.29 | 0.08 | 0.025 | 0.01 | 1.5 | 170 | ◯ | 4500 | 97 | 49 | 85 | 390 | 490 |
| AL-12 | 0.4 | 0.29 | 0.08 | 0.025 | 0.01 | 1.5 | 145 | ◯ | 4500 | 87 | 43 | 79 | 270 | 350 |
| AL-13 | 0.5 | 0.29 | 0.08 | 0.025 | 0.01 | 1.5 | 140 | ◯ | 4500 | 85 | 41 | 77 | 250 | 320 |

(1) Relation Between Plate Thickness t of Aluminum Plate and Tensile Strength TS in Rolling Direction

The tensile strengths TS of each obtained aluminum plate in a rolling direction were measured by using the specimens with width of 25 mm with Shimazu Corporation-made Auto Graph according to JIS Z2201 and JIS Z2241. Whether or not the measured values TS and the plate thickness t satisfied the relation with the following equation (I) was checked. Those results are shown in Table 1. In Table 1, when the relation is satisfied, it is determined to be “◯” and when the relation is not satisfied, it is determined to be “X”.

−98.6×t+170≦TS (MPa)≦−98.6×t+200 Equation [1]

(2) Number of Intermetallic Compounds Per Unit Area (Pieces) and Occupation Rate of Intermetallic Compounds with a Circle Equivalent Diameter of 1 to 10 μm

For each obtained aluminum plate, the aluminum plates from which an oil was wiped out with acetone were used as the specimens for measurement.

An instant photography was obtained by photographing a composition image with a reflection absorption spectroscopic electron detector used under the conditions of acceleration voltage of 20.0 kV and irradiation current of 9.5×10⁻⁹ A with an electron probe micro analyzer (EPMA, JEOL Ltd.-made, JEOL SUPERPROBE JXA-8800M) at 500-fold magnification.

Next, after the obtained reflection electron photography (instant photography) was scanned, the scanned image was outputted to Photoshop 5.0 in gray scale (14 bits) at output resolution of 75 dpi with an attached ScanGear CS-U, the image was saved in TIF format and the image was converted into a bmf (bit map file) format with MS-Paint (Microsoft Corporation-made).

After the bmf formatted file was read in an image analysis software ImageFactroy Ver. 3. 2 Japanese Version (Asahi Hightech Co., Ltd.-made) to analyze the image, a static binary processing was performed, the areas which is void corresponding to the intermetallic compound were counted and the a circle equivalent diameter (equivalent circle diameter) was designated as the specified trace quantity to obtain the particle size distribution.

The results led to the calculations of the number of the intermetallic compounds per unit area (merely indicated as “Pieces” in Table 1) and the occupation rate of the intermetallic compounds with a circle equivalent diameter of 1 to 10 μm (merely indicated as “Occupation rate” in Table 1).

The results are shown in Table 1.

(3) Measurement of Size of Crystal Grain

For each obtained aluminum plate, the surface was almost finished so as to allow the surface roughness Rₐ (Arithmetic average roughness defined in JIS B0601-1994 (Cut-off value: 0.8 mm, Evaluated length: 4 mm)) to be 0.2 with a #800 waterproof polishing paper, and after an about 1 to 1.5 μm-buffing was further performed on the surface with an alumina suspension (particle diameter: 0.05 μm), an about 0.5 to 1.0 μm-etching treatment was performed on the surface with a 10% hydrofluoric acid aqueous solution. The arrangement thus made could observe the crystal grain interfaces, the crystal structure was photographed with a polarization microscope, the widths and lengths of the crystal grains of 20 pcs located in the areas from the surface of the aluminum plate to the depth of 50 μm were measured to find the average value and the maximum value. The results are shown in Table 1.

Note that for each presensitized plate where the image recording layers were provided after graining treatment later described was performed, after all the image recording layers were removed, the crystal structure was observed in the same method, whose results were almost the same as in the aforementioned results.

<Surface Treatment>

Various surface treatments of the following (a) to (l) were continuously performed on each of the aluminum plates AL-1 to AL-13 to obtain each support for a lithographic printing plate.

Note that after each treatment, water washing was performed, and then, liquid separation was performed with a nip roller.

Hereafter, each surface treatment (a) to (l) will be described.

(a) Mechanical Graining Treatment (Brush Graining Treatment)

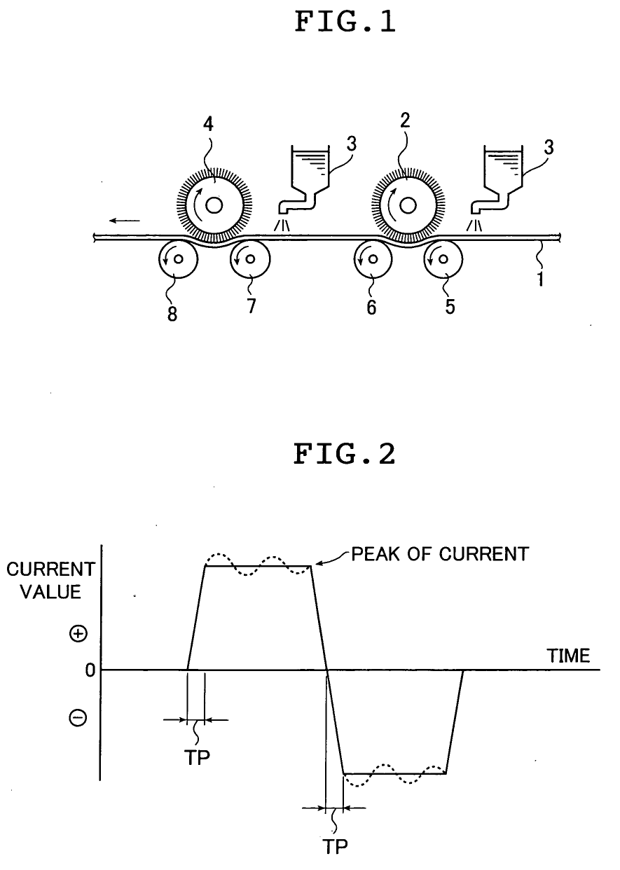

Mechanical graining treatment was performed on the surface of the aluminum plate by a rotating brush (bundle-implanted brushes of 3 pcs and channel brush of 1 pc) while supplying the suspension (specific gravity: 1.1 g/cm³) of a pumice (median diameter: 33 μm) as a abrasive slurry liquid using the equipment, as shown in FIG. 1. FIG. 1 is a side view showing the process concept of the brush graining treatment used for the mechanical graining treatment in the preparation of the support for a lithographic printing plate according to the present invention, and in FIG. 1, 1 represents an aluminum plate, 2 and 4 represent roller-shaped brushes, 3 represents an abrasive slurry liquid and 5, 6, 7 and 8 represent the support rollers.

In the mechanical graining treatment, the brushes used the bundle-implanted brush, the channel brush, the bundle-implanted brush and the bundle-implanted brush in the order from the upstream side (on the right hand in FIG. 1) to the transferring direction of the aluminum plate. These rotation direction and rotation speed were determined to be the clockwise rotation (in the same direction as in the transferring direction): 250 rpm, the counterclockwise rotation (in the reverse direction to the transferring direction): 200 rpm, the counterclockwise rotation: 200 rpm and the clockwise rotation: 200 rpm in the order to the transferring direction of the aluminum plate (the arrow shown in FIG. 1).

The material of the brush was 6·10 nylon, the diameter of the brush bristles was 0.3 mm and the length of the bristle was 50 mm. The brush was prepared by boring holes on a dia. 300 mm-stainless steel cylinder and implanting the bristles on it so as to be thick. The distance between the two support rollers (dia. 200 mm) beneath the brush was 300 mm. Each brush roller was pressed until the load of the drive motor which rotated the brush reached a load which was increased by 7 kW to a load before the brush was pressed against the aluminum plate.

(b) Alkali Etching Treatment

Alkali etching treatment was performed by spraying an alkali solution (60° C.) containing NaOH of 26 wt % and aluminum ion of 5 wt % onto the aluminum plate after mechanical graining treatment from a spray tube so as to allow the meltage of aluminum to be 9 g/m on the grained surface.

(c) Desmutting Treatment

Desmutting treatment was performed by using an acid aqueous solution with nitric acid concentration of 1 wt % at 30° C. Desmutting treatment was performed by spraying the desmutting solution with a spray tube for 2 seconds.

(d) Electrolytic Graining Treatment

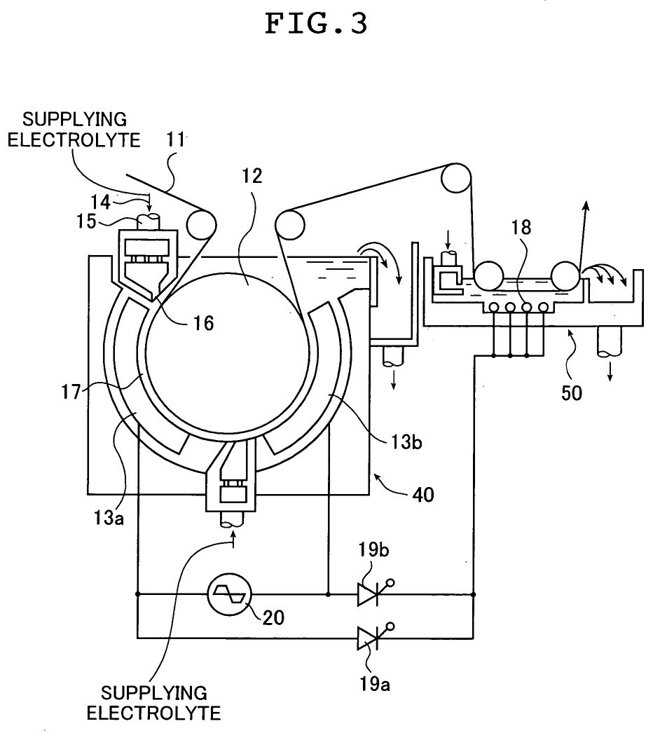

Electrolytic graining treatment was performed by applying the trapezoidal wave current of the wave shown in FIG. 2 using the electrolytic bath shown in FIG. 3 in a nitric acid electrolytic solution where the concentration of aluminum ion was controlled at 0.5 wt % by adding aluminum nitrate to a nitric acid aqueous solution with nitric acid concentration of 1 wt % at the solution temperature of 40° C. The frequency of the aforementioned trapezoidal wave current was 60 Hz, the quantity of electricity at the time of the anodic reaction in the aforementioned aluminum plate was 197 C/dm² and the current density was 25 A/dm² at the time of the anodic reaction in the aluminum plate at the peak of AC. Duty of AC (ratio of time to frequency at a time when an aluminum plate was an anode) was 0.5, and the risetime TP was 0.3 msec. The ratio Qc/Qa of the total sum Qa of the quantity of electricity at the time of anodic reaction in the aluminum plate to the total sum Qc of the quantity of electricity at the time of cathodic reaction in the aluminum plate at a position where the aluminum plate was opposite to the main carbon electrode was 0.95. The quantity of electricity applied to the aluminum plate is a quantity of electricity applied to an aluminum plate while the aluminum plate passes through an electrolytic bath and is the total sum of the quantity of electricity produced by the anodic reaction of the aforementioned aluminum plate.

The nitric acid concentration of the aforementioned nitric acid electrolytic solution was controlled by measuring the sonic speed and conductivity of the aforementioned nitric acid electrolytic solution at certain intervals of time and replenishing a concentrated nitric acid or water thereto so as to allow the fluctuation range between the aforementioned sonic speed and conductivity to be within ±10%.

Note that FIG. 2 is a graph showing one example of an alternating current wave diagram used for electrolytic graining treatment using AC in the preparation of the support for a lithographic printing plate according to the present invention.

FIG. 3 is a side view showing one example of a radial-type cell in electrolytic graining treatment using AC in the preparation of the support for a lithographic printing plate according to the present invention. In FIG. 3, 11 represents an aluminum plate, 12 represents a radial drum roller, 13a and 13b represent main electrodes, 14 represents an electrolytic treatment solution, 15 represents an electrolytic solution supply port, 16 represents a slit, 17 represents an electrolytic solution channel, 18 represents an auxiliary electrode, 19a and 19b represent shyristors, 20 represents AC power supply, 40 represents main electrolytic bath and 50 represents an auxiliary anode tank.

(e) Alkali Etching Treatment

Alkali etching treatment was performed by spraying an alkali solution (35° C.) containing NaOH of 26 wt % and aluminum ion of 5 wt % onto the aluminum plate after electrolytic graining treatment (d) from a spray tube so as to allow the meltage of aluminum on the grained surface to be 3.8 g/m².

(f) Desmutting Treatment

Desmutting treatment was performed by spraying an acid aqueous solution with sulfuric acid concentration of 25 wt % at the solution temperature of 60° C. with a spray tube for 2 seconds.

(g) Electrolytic Graining Treatment

Electrolytic graining treatment was performed by applying the trapezoidal wave current of the wave shown in FIG. 2 using the electrolytic bath shown in FIG. 3 in a hydrochloric acid electrolytic solution where the solution temperature was 30° C., the hydrochloric acid concentration was 0.5 wt % and the concentration of aluminum ion was 0.5 wt %. The frequency of the aforementioned trapezoidal wave current was 60 Hz, the quantity of electricity at the time of the anodic reaction in the aluminum plate was 60 C/dm² and the current density was 30 A/dm² at the time of the anodic reaction in the aluminum plate at the peak of AC. Duty of AC (ratio of time to frequency at a time when an aluminum plate was an anode) was 0.5, and the risetime TP was 0.5 msec. The ratio Qc/Qa of the total sum Qa of the quantity of electricity at the time of anodic reaction in the aluminum plate to the total sum Qc of the quantity of electricity at the time of cathodic reaction in the aluminum plate at a position where the aluminum plate was opposite to the main-carbon electrode was 0.95. The quantity of electricity applied to the aluminum plate is a quantity of electricity applied to an aluminum plate while the aluminum plate passes though an electrolytic bath and is the total sum of the quantity of electricity produced by the anodic reaction in the aforementioned aluminum plate.

The hydrochloric acid concentration of the aforementioned hydrochloric acid electrolytic solution was controlled by measuring the sonic speed and conductivity of the aforementioned hydrochloric acid electrolytic solution at the certain intervals of time and replenishing a concentrated hydrochloric acid or water thereto so as to allow the fluctuation range between the aforementioned sonic speed and conductivity to be within ±10%.

(h) Alkali Etching Treatment

Alkali etching treatment was performed by spraying an alkali solution (45° C.) containing NaOH of 5 wt % and aluminum ion of 0.5 wt % onto the aluminum plate after electrolytic graining treatment (g) from a spray tube so as to allow the meltage of aluminum on the grained surface to be 0.1 g m².

(i) Desmutting Treatment

Desmutting treatment was performed by spraying an acid aqueous solution with sulfuric acid concentration of 25 wt % at the solution temperature of 60° C. with a spray tube for 4 seconds.

(j) Anodizing Treatment

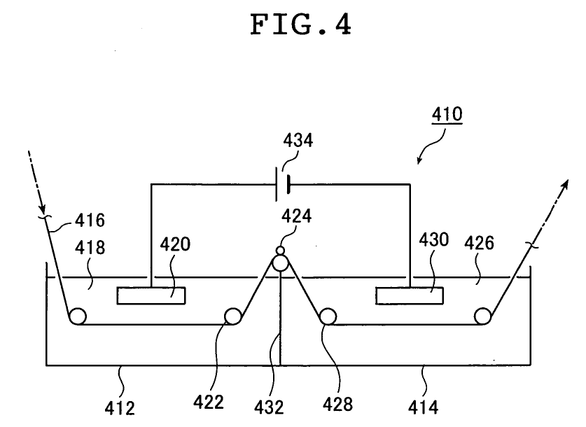

Anodizing treatment was performed by using the anodizing device with DC electrolysis in the structure shown in FIG. 4. The electrolytic solution supplied to the first and second electrolytic sections used sulfuric acid. The electrolytic solution therefor was each the sulfuric acid concentration of 15 wt % (containing aluminum ion of 0.5 wt %) at a temperature of 38° C. The final quantity of anodized layer was 2.5 g/m².

FIG. 4 is a schematic view of the anodizing device used for anodizing treatment in the preparation of the support for a lithographic printing plate according to the present invention. In FIG. 4, 410 represents anodizing treatment device, 412 represents a power supply tank, 414 represents an electrolytic treatment tank, 416 represents an aluminum plate, 418 and 426 represent electrolytic solutions, 420 represents a power supply electrode, 422 and 428 represent rollers, 424 represents a nip roller, 430 represents an electrolytic electrode, 432 represents a tank wall and 434 represents DC power supply.

(k) Sealing Treatment

Sealing treatment was performed in a saturated steam chamber at 100° C. under 1 atm for 10 seconds.

(1) Silicate Treatment

Dipping treatment was performed in No. 3 sodium silicate aqueous solution (Na₂O:SiO₂=1:3, Content of SiO₂:30 wt %, Nippon chemical Industrial CO, LTD.-made, Concentration: 1 wt %) for 10 seconds. The final Si atom adhesion quantity was 3.5 g/m².

2. Preparation of Lithographic Printing Plate

A presensitized plate was obtained by providing the below-mentioned two-layer structured image recording layer of thermal positive type on each support for a lithographic printing plate obtained above.

<Photosensitive Layer>

The undercoat layer coating solution I with the following composition was coated on the supports described above and dried at 80° C. for 30 seconds. The coated quantity after drying was 30 mg/m².

<Composition of undercoat layer coating solution I>

| | | |
|---|---|---|
| The high-molecular compound A expressed by the | 0.3 | g |
| following formula | | |
| Methanol | 100 | g |
| Water | 1 | g |

| | |
|---|---|
| 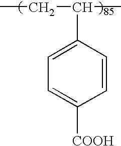 | 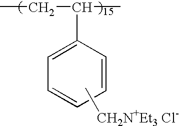 |
| Mw 28,000 | |

A thermosensitive layer coating solution A with the following composition was coated on the undercoat layer and the thermosensitive layer coating solution A was dried at 140° C. for 50 seconds with Wind Control set at 7 on PERFECT OVEN PH200 made by TABAI Co., Ltd. to form the thermosensitive layer A. The coated quantity after drying was 0.85 g/m².

<Composition of a thermosensitive layer coating
solution A>

| | | |
|---|---|---|
| Copolymer of N-(4-aminosulpfonyl)methacrylamide/ | 1.896 | g |
| acrylonitrile/methyl methacrylate (mol ratio: 36/34/30, | | |
| weight average molecular weight 50,000) | | |
| Cresol-novolak resin (m/p ratio = 6/4, weight | 0.237 | g |
| average molecular weight 4,500, 0.8 wt % of residual | | |
| monomer) | | |
| Cyanine dye A expressed by the following formula | 0.109 | g |
| 4,4′-bishydroxyphenylsulfone | 0.063 | g |
| Tetrahydrophthalic anhydride | 0.190 | g |
| p-toluenesulfonic acid | 0.008 | g |
| A compound prepared by setting a counter ion of | 0.05 | g |
| ethyl violet as 6-hydroxynaphthalene sulfone | | |
| Fluorine-containing surfactant (Megafac F-176, made | 0.035 | g |
| by Dainippon Ink And Chemicals, Incorporated) | | |
| Methyl ethyl ketone | 26.6 | g |
| 1-methoxy-2-propanol | 13.6 | g |
| γ-butyllactone | 13.8 | g |
| Cyanine dye A | | |

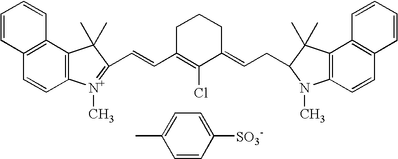

Therefore, a thermosensitive layer coating solution B with following composition was coated on the thermosensitive layer A and an image recording layer of a two-layer structure was formed by drying the thermosensitive layer B at 120° C. for one minute to obtain a presensitized plate. The coated quantity of the thermosensitive layer B after drying was 0.15 g/m².

<Composition of a Thermosensitive Layer Coating Solution B>

| | |
|---|---|
| m, p-cresol novolak resin (m/p ratio = 6/4, weight | 0.237 g |
| average molecular weight 4,500, containing 0.8 wt % of | |
| unreacted cresol) | |
| Cyanine dye A expressed by the aforementioned | 0.047 g |
| formula | |
| Dodecyl stearate | 0.060 g |
| 3-methoxy-4-diazodiphenylaminehexafluorophosphate | 0.030 g |
| Fluorine-containing surfactant (Megafac F-176, made | 0.110 g |
| by Dainippon Ink And Chemicals, Incorporated) | |
| Fluorine-containing surfactant (Megafac MCF-312 | 0.120 g |
| (30 wt %), made by Dainippon Ink And Chemicals, | |
| Incorporated) | |
| Methyl ethyl ketone | 15.1 g |
| 1-methoxy-2-pronanol | 7.7 g |

3. Exposure and Development Processing

A lithographic printing plate was obtained by performing exposure and development processing on each presensitized plate obtained above with the following method.

An image-wise exposure was performed on each of the obtained presensitized plates at main scanning speed of 5 m/sec. at plating plate energy of 140 mJ/cm² using CREO Inc.-made TrendSetter 3244 equipped with a semiconductor laser with an output of 500 mW, a wavelength of 830 nm and a beam diameter of 17 μm(1/e²)

Thereafter, development processing was performed by using an alkali developer (a developer substantially containing no alkali metal silicate and containing saccharides) where C₁₂H₂₅N(CH₂CH₂COONa)₂ of 1.0 g was added to an aqueous water of 1 L containing a potassium salt of 5.0 wt % consisting of D-sorbitol/potassium oxide (K₂O) that a non-reducing sugar and a base were combined and an antifoamer (Olefin AK-02, Nissin chemical Industry Co., Ltd.-made) of 0.015 wt %. Development processing was performed under the conditions of development temperature of 25° C. for 12 seconds using an automatic development processor PS900NP (Fuji Photo Film Co., Ltd.-made) filled with the developer. After the development processing was over, water washing process was performed, the plate was treated with gum (GU-7 (1:1)) or the like and the lithographic printing plate with plate completed was obtained.

4. Evaluation of Lithographic Printing Plate

Evaluated with the following methods were existence or non-existence of defective exposure (sensitivity), cleaner press life, scum resistance (inability of ink spreading), handling property (mechanical strength), press life and surface quality (external appearance) of each lithographic printing plate obtained above.

The evaluation results of sensitivity, cleaner press life and scum resistance are shown in Table 2.

(1) Sensitivity: Existence or Non-Existence of Defective Exposure

For existence or non-existence of defective exposure of each lithographic printing plate, the occurrence frequency of dotted exposure insufficient sections (existence or non-existence of dot residual layers and its degree) was visually observed on the lithographic printing plates on which exposure and development processing were performed above for evaluation. The three-step evaluation of “◯”, “Δ” and “X” was conducted according to the extent of defective exposure (the aforementioned occurrence frequency). Above “Δ” are allowable.

(2) Cleaner Press Life

Printing was performed on the lithographic printing plates on which exposure and development processing were performed above using Komori Corporation-made SPRINT printing press with Dainippon Ink And Chemicals, Incorporated-made F-Gloss 85 black ink, the solid-image area was washed with a plate cleaner solution (multicleaner, Fuji Photo Film Co., Ltd-made) with a sponge every 5,000 sheet-printing, and the evaluation was performed depending upon the number of printing until that the solid-image section began to be dim could be visually observed.

Note that cleaner press life is shown at the relative value where the cleaner press life in Comparative Example 1 is 100.

(3) Scum Resistance

Scum resistance was evaluated by the inability of ink spreading.

Printing was performed on the lithographic printing plates on which exposure and development processing were performed above using Mitsubishi Dia-type F2 Printing Press (Mitsubitshi Heavy Industries, Ltd.-made) with DIC-GEOS (s) scarlet ink, the scum of the blanket after 10,000 sheets were printed was once transferred onto a cellophane tape (trademark), which was attached to a white paper, and the quantity of the ink transferred onto the cellophane tape (trademark) was visually evaluated.

The evaluation was performed in the six-step of “⊚”, “◯”, “◯Δ”, “Δ”, “ΔX” and “X” in order from the smallest scum.

Above “◯Δ” are allowable.

(4) Press Life

Printing was performed on the lithographic printing plates on which exposure and development processing were performed above by using Komori Corporation-made SPRINT Printing Press as a printing press and a solution where isopropanol was added to Fuji Photo Film Co., Ltd.-made EU-3 (1%) so as to allow isopropanol to be 10 wt % to the whole weight as a fountain solution.

The evaluation was performed depending upon the number of printing until that the solid-image section began to be dim was visually observed.

Note that excellent press life could be realized in any of the Examples as compared to the printed sheets in the Comparative Examples.

(5) Handling Property (Mechanical Strength)

Plate-tear when the lithographic printing plate on which exposure and development processing were performed above was mounted on the plate cylinder of the printing press and whether or not plate-tear or the like in printing would occur were tested.

As a result, Examples 1 to 9 were particularly excellent in handling property (mechanical strength).

(6) Surface Quality (External Appearance)

Visually observed were whether or not stripe-shaped patterns could be confirmed on the non-image areas exposed on the lithographic printing plate on which exposure and development processing were performed above and whether or not the non-image areas were glaringly seen.

As a result, Examples 1 to 9 were particularly excellent in surface quality (external appearance) and also in plate inspection property. Comparative Example 3 was poor in surface quality (external appearance).

TABLE 2

| | Aluminum | | Cleaner | Scum |
|---|---|---|---|---|
| | Plate | Sensitivity | press life | resistance |
| Example 1 | AL1 | ◯ | 120 | ◯ |
| Example 2 | AL2 | ◯ | 110 | ◯ |
| Example 3 | AL3 | ◯ | 120 | ◯ |
| Example 4 | AL4 | ◯ | 125 | ◯Δ |
| Example 5 | AL9 | ◯ | 120 | ◯ |
| Example 6 | AL10 | ◯ | 120 | ◯ |
| Example 7 | AL11 | ◯ | 120 | ◯ |
| Example 8 | AL12 | ◯ | 120 | ◯ |
| Example 9 | AL13 | ◯ | 120 | ◯ |
| Example 10 | AL8 | Δ | 100 | ◯ |
| Comparative | AL5 | X | 100 | Δ |
| Example 1 | | | | |
| Comparative | AL6 | ◯ | 70 | ◯ |
| Example 2 | | | | |
| Comparative | AL7 | ◯ | 125 | ΔX |
| Example 3 | | | | |

As shown in Table 2, the supports for a lithographic printing plates (Examples 1 to 10) using the aluminum plates according to the present invention and the presensitized plates using the same were excellent in all of sensitivity, cleaner press life, scum resistance and press life when the lithographic printing plates were prepared.

In addition, the supports for a lithographic printing plates (Examples 1 to 9) using the aluminum plate according to the present invention where the plate thickness t and tensile strength TS of the aluminum plate are related in a particular relation and the presensitized plates using the same were more excellent in cleaner press life, and in addition, they were particularly excellent in handling property where tear, breaking or the like of the plate does not occur when the plate was mounted on the printing press and in printing (mechanical strength).

Furthermore, the supports for a lithographic printing plate (Examples 1 to 9) using the aluminum plate according to the present invention where the pieces and the occupation rate of the intermetallic compounds in the specified ranges and the presensitized plates using the same were more excellent in sensitivity.

Moreover, the supports for a lithographic printing plate (Examples 1 to 9) using the aluminum plate according to the present invention where the sizes of the crystal grains in the aluminum plate in the specified range and the presensitized plates using the same were more excellent in surface quality (external appearance).

On the contrary, if the aluminum plate according to the present invention where the contents of the specified elements contained in the aluminum plate are out of the scope according to the present invention is used, the plate was poor in one of sensitivity, cleaner press life, scum resistance and press life.

### Examples 11 to 13 and Comparative Examples 4 to 7

1. Preparation of Support for Lithographic Printing Plate

### Examples 11 to 13

The aforementioned graining treatment (a) to (k) were performed by using the aluminum plate AL 2 obtained above in the same manner as in the aforementioned Example 2.

Thereafter, silicate treatment (1) was performed by changing the concentration and temperature of No. 3 sodium silicate aqueous solution used for the treatment and controlling the final Si atom adhesion quantity at the values shown in Table 3.

Concretely, in Example 11, silicate treatment was performed by changing the temperature of the aqueous solution to 70° C. and the concentration to 5 wt %, in Example 12, silicate treatment was performed by changing the temperature of the aqueous solution to 50° C. and the concentration to 5 wt %, and in Example 13, silicate treatment was not performed.

### Comparative Examples 4 to 7

The aforementioned graining treatments (a) to (k) were performed by using the aluminum plate AL 6 obtained above in the same manner as in the aforementioned Comparative Example 2.

Thereafter, silicate treatment (1) was performed by changing the concentration and temperature of No. 3 sodium silicate aqueous solution used for the treatment and controlling the final Si atom adhesion quantity at the values shown in Table 3.

Concretely, in Comparative Example 4, silicate treatment was performed by changing the temperature of the aqueous solution to 70° C. and the concentration to 6 wt %, in Comparative Example 5, silicate treatment was performed by changing the temperature of the aqueous solution to 70° C. and the concentration to 5 wt %, and in Comparative Example 6, silicate treatment was performed by changing the temperature of the aqueous solution to 50° C. and the concentration to 5 wt %. However, in Comparative Example 7, silicate treatment was not performed.

Si atom adhesion quantity onto the surface of each support for a lithographic printing plate was measured by using X-ray Flourescence Spectrometer shown below in the calibration curve method. The results are shown in Table 3.

As a standard specimen to prepare the calibration curve, after a sodium silicate aqueous solution containing the known quantity of Si atom was uniformly dropped in an area of 30 mm dia. on the aluminum plate, the solution was dried and the dried substance was used. The conditions of the flourescent X-ray analysis are shown below.

X-ray Flourescence Spectrometer: RIGAKU Corporation—made RIX 3000, X-ray lamp; RH, Measurement spectrum: Si—Kα, lamp voltage: 50 kV, lamp current: 50 mA, Slit: COARSE, analyzing crystal: RX 4, detector: F-PC, analyzing area: 30 mm dia., peak position (2θ): 144.75 deg., background (2θ): 140.70 deg. and 146.85 deg., total elapsed time: 80 sec./sample.

2. Preparation of Presensitized Plate

The presensitized plate was obtained by providing the image recording layer of a two-layer structure of thermal positive type on each support for a lithographic printing plate obtained above.

3. Exposure and Development Processing

Each lithographic printing plate was obtained by performing the same exposure and development as in the aforementioned (“exposure and development method A” is determined in Table 3) on Examples 2, 11, 12, and Comparative Examples 4 to 7.

For Example 13, exposure was performed on the obtained presensitized plate at main operation speed of 5 m/sec. and printing plate energy of 140 mJ/cm² with a semiconductor laser with output of 500 mW, wavelength of 830 nm and beam diameter of 17 μm (1/e²). Thereafter, development was performed with an automatic development processor (Fuji Photo Film Co., Ltd.-made PS Processor 900VR) provided with a Fuji Photo Film Co., Ltd.-made developer DP-4 water-diluted solution (1:8 , a developer containing sodium silicate) and rinse solution FR-3 (1:7, “exposure and development method B in Table 3”).

4. Evaluation of Lithographic Printing Plate

Evaluated on each lithographic printing plate obtained above with the aforementioned method were existence or non-existence of defective exposure (sensitivity), cleaner press life, scum resistance (inability of ink spreading), handling property (mechanical strength), press life and surface quality (external appearance).

The results are shown in Table 3.

In addition, (1) Sensitivity: The evaluation of existence or non-existence of defective exposure was performed in the four steps of “⊚”, “◯”, “Δ” and “X” according to the extent of defective exposure.

TABLE 3

| | Si atom | | | | |
|---|---|---|---|---|---|
| | adhesion | | | Cleaner | |
| | quantity | Development | | press | Scum |
| | (mg/m²) | method | Sensitivity | life | resistance |
| Example 11 | 20 | A | ⊚ | 100 | ⊚ |
| Example 12 | 10 | A | ⊚ | 105 | ⊚ |
| Example 2 | 3.5 | A | ◯ | 110 | ◯ |
| Example 13 | 0 | B | Δ | 120 | ⊚ |
| Comparative | 25 | A | ⊚ | 0 | ⊚ |
| Example 4 | | | | | |
| Comparative | 20 | A | ⊚ | 40 | ⊚ |
| Example 5 | | | | | |
| Comparative | 10 | A | ⊚ | 50 | ⊚ |
| Example 6 | | | | | |
| Comparative | 3.5 | A | ◯ | 70 | ◯ |
| Example 2 | | | | | |
| Comparative | 0 | A | X | 110 | X |
| Example 7 | | | | | |

Although, as mentioned above, the presensitized plate using the support for a lithographic printing plate according to the present invention is excellent in all of sensitivity, cleaner press life, scum resistance and press life, as shown in Table 3, the presensitized plate using the support for a lithographic printing plate according to the present invention where Si atom adhesion quantity within the scope of the present invention (Examples 2, 11 and 12) was particularly excellent in sensitivity and scum resistance, without impairing cleaner press life.

On the contrary, the presensitized plate using the support for a lithographic printing plate where the contents of the-specified elements contained in the aluminum plate were out of the scope of the present invention was very poor in at least one of sensitivity, cleaner press life, scum resistance and press life even though Si atom adhesion quantity was allowed within the scope of the present invention.

The support for a lithographic printing plate using the aluminum plate according to the present invention where the contents of the specified elements are controlled within the scope of the present invention and the presensitized plate using the same are excellent in all of sensitivity, cleaner press life, scum resistance and press life when the lithographic printing plate is prepared.

In addition, the support for a lithographic printing plate using the aluminum plate where-the specified elements of the aforementioned contents are contained and the plate thickness and tensile strength of the aluminum plate are in a particular relation and the presensitized plate using the same are excellent in all of sensitivity, cleaner press life, scum resistance and press life and is further excellent in mechanical strength when the lithographic printing plate is prepared.

Furthermore, the support for a lithographic printing plate using the aluminum plate according to the present invention where the sizes of the crystal grains contained in the aluminum plate are specified and the presensitized plate using the same are excellent in surface quality (external appearance), besides the aforementioned characteristics.

Still furthermore, even if the presensitized plate using the support for a lithographic printing plate according to the present invention is provided with a laser exposed-type image recording layer as an image recording layer, the plate is excellent in all of sensitivity, cleaner press life, scum resistance and press life when the lithographic printing plate is prepared, and can be treated with a developer containing no alkali metal silicate as well.

What is claimed is:

1. A support for a lithographic printing plate obtained by performing graining treatment including electrochemical graining treatment on an aluminum plate, wherein said aluminum plate contains Fe of 0.05 to 0.29 wt %, Si of 0.03 to 0.15 wt %, Cu of 0.020 to 0.050 wt % and Ti of 0.05 wt % or less and the remaining portion thereof is composed of aluminum and unavoidable impurities.

2. The support for a lithographic printing plate according to claim 1, wherein said aluminum plate is such that the plate thickness t (mm) thereof is 0.10 to 0.50 (mm) and the relation between said plate thickness t (mm) and the tensile strength TS (MPa) of said aluminum plate in a rolling direction satisfies the following equation [I].
−98.6−t+170≦TS (MPa)≦−98.6×t+200 Equation [1]

3. The support for a lithographic printing plate according to claim 1, wherein said aluminum plate is such that for an intermetallic compounds are existent on the surface thereof, an intermetallic compound with a circle equivalent diameter of 1 μm or more is of 6,000 pieces/mm² or less and the rate of an intermetallic compound with a circle equivalent diameter of 1 to 10 μm is 85% or higher.

4. The support for a lithographic printing plate according to claim 2, wherein said aluminum plate is such that for an intermetallic compounds are existent on the surface thereof, an intermetallic compound with a circle equivalent diameter of 1 μm or more is of 6,000 pieces/mm² or less and the rate of an intermetallic compound with a circle equivalent diameter of 1 to 10 μm is 85% or higher.

5. The support for a lithographic printing plate according to claim 1, wherein said aluminum plate is such that for crystal grains located in the area up to 50 μm deep from the surface thereof, the width in a direction perpendicular to a plate rolling direction is an average of 80 μm or less and a maximum of 150 μm or less, and the length of the plate rolling direction is an average of 400 μm or less and a maximum of 500 μm or less.

6. The support for a lithographic printing plate according to claim 2, wherein said aluminum plate is such that for crystal grains located in the area up to 50 μm deep from the surface thereof, the width in a direction perpendicular to a plate rolling direction is an average of 80 μm or less and a maximum of 150 μm or less, and the length of the plate rolling direction is an average of 400 μm or less and a maximum of 500 μm or less.

7. The support for a lithographic printing plate according to claim 3, wherein said aluminum plate is such that for crystal grains located in the area up to 50 μm deep from the surface thereof, the width in a direction perpendicular to a plate rolling direction is an average of 80 μm or less and a maximum of 150 μm or less, and the length of the plate rolling direction is an average of 400 μm or less and a maximum of 500 μm or less.

8. The support for a lithographic printing plate according to claim 1, wherein Si atom adhesion quantity onto the surface of said aluminum plate is 0.1 to 30 mg/m².

9. The support for a lithographic printing plate according to claim 2, wherein Si atom adhesion quantity onto the surface of said aluminum plate is 0.1 to 30 mg/m².

10. The support for a lithographic printing plate according to claim 3, wherein Si atom adhesion quantity onto the surface of said aluminum plate is 0.1 to 30 mg/².

11. The support for a lithographic printing plate according to claim 5, wherein Si atom adhesion quantity onto the surface of said aluminum plate is 0.1 to 30 mg/m².

12. A presensitized plate provided with an image recording layer on the support for a lithographic printing plate according to claim 1.

13. A presensitized plate provided with an image recording layer on the support for a lithographic printing plate according to claim 2.

14. A presensitized plate provided with an image recording layer on the support for a lithographic printing plate according to claim 3.

15. A presensitized plate provided with an image recording layer on the support for a lithographic printing plate according to claim 5.

16. The presensitized plate according to claim 12, which is a presensitized plate for a laser printing plate.

17. A method of treating a presensitized plate, wherein after exposure is performed on the presensitized plate according to claim 12, development is performed with a developer substantially containing no alkali metal silicates and containing saccharides.

18. A method of treating a presensitized plate, wherein after exposure is performed on the presensitized plate according to claim 13, development is performed with a developer substantially containing no alkali metal silicates and containing saccharides.

19. A method of treating a presensitized plate, wherein after exposure is performed on the presensitized plate according to claim 14, development is performed with a developer substantially containing no alkali metal silicates and containing saccharides.

20. A method of treating a presensitized plate, wherein after exposure is performed on the presensitized plate according to claim 15, development is performed with a developer substantially containing no alkali metal silicates and containing saccharides.
